(19) United States
(12) Patent Application Publication
(10) Pub. No.: US 2025/0202558 A1
(43) Pub. Date: Jun. 19, 2025

(54) METHODS, ARCHITECTURES, APPARATUSES AND SYSTEMS FOR CHANNEL STATE INFORMATION MEASUREMENT AND REPORTING IN WIRELESS COMMUNICATIONS

(71) Applicant: InterDigital Patent Holdings, Inc., Wilmington, DE (US)

(72) Inventors: Young Woo Kwak, Woodbury, NY (US); Moon-IL Lee, Melville, NY (US); Paul Marinier, Brossard (CA); Nazli Khan Beigi, Longueuil (CA)

(21) Appl. No.: 18/851,808

(22) PCT Filed: Mar. 29, 2023
(86) PCT No.: PCT/US2023/016749

§ 371 Date: Sep. 27, 2024

Related U.S. Application Data
(60) Provisional application No. 63/325,375, filed on Mar. 30, 2022.

(51) Int. Cl. H04B 7/06; H04B 17/309; H04B 17/318; H04W 76/20

(52) U.S. Cl. CPC H04B 7/0626; H04B 7/0632; H04B 17/328; H04B 17/346; H04W 76/20

(57) ABSTRACT

Procedures, methods, architectures, apparatuses, systems, devices, and computer program products for reference signal (RS) transmission, channel state information (CSI) measurements, and CSI reporting. In an example embodiment, a wireless transmit/receive unit (WTRU) may be configured with multiple CSI-RS resource sets. A CSI-RS resource set may be associated with transmission and/or reception of non-orthogonal CSI-RSs. Neighboring beam groups may share a same CSI-RS resource set. The WTRU may receive CSI-RS transmissions using the CSI-RS resource sets. For example, the WTRU may (e.g., determine to, be indicated to, be configured to) switch from CSI measurement of a first CSI-RS resource set to a second CSI-RS resource set. For example, the WTRU may switch from CSI measurement of the resource sets using a first measurement configuration to a second measurement configuration. For example, the WTRU may switch from applying a first quasi co-located (QCL) configuration to a second QCL configuration to the resource sets.

### CROSS-REFERENCE TO RELATED APPLICATIONS

This application claims the benefit of U.S. Provisional Patent Application No. 63/325,375 filed 30 Mar. 2022, which is incorporated herein by reference.

### TECHNICAL FIELD

The present disclosure is generally directed to the fields of communications, software and encoding, including, for example, to methods, architectures, apparatuses, systems directed to measurement and reporting of channel state information (CSI).

### BACKGROUND

There exists a minimum of 5 GHz of spectrum available globally, between 57 to 64 GHz, for unlicensed operation and in some countries up to 14 GHz of spectrum, between 57 and 71 GHz, for unlicensed operation. A minimum of 10 GHz of spectrum is also available globally, between 71 to 76 GHz and 81 to 86 GHz, for licensed operation and in some countries up to 18 GHz of spectrum available, between 71 and 114.25 GHz, for licensed operation. Frequency ranges above 52.6 GHz potentially contain larger spectrum allocations and larger bandwidths that are not available for bands lower than 52.6 GHz. However, physical layer channels of 3GPP 5^{th} Generation New Radio were designed to be optimized for uses under 52.6 GHz.

### SUMMARY

In certain representative embodiments, a wireless transmit/receive unit (WTRU) may receive (e.g., from a base station) configuration information indicating a first set of transmission configuration index (TCI) states associated with a first scrambling identifier (ID) and a second set of TCI states associated with a second scrambling ID. The WTRU may receive (e.g., from the base station) channel state information (CSI) reporting information indicating a first CSI reference signal (CSI-RS) resource set associated with the first set of TCI states and a second CSI-RS resource set associated with the second set of TCI states. The WTRU may report (e.g., to the base station) first CSI including information indicating a quality of the first CSI-RS resource set based on one or more first measurements. The one or more first measurements may be based on (e.g., performed using) the first CSI-RS resource set and the first scrambling ID. The WTRU may report (e.g., to the base station), based on (1) the quality of the first CSI-RS resource set being less than a first threshold and (2) a difference between a quality of the second CSI-RS resource set based on one or more second measurements and the quality of the first CSI-RS resource set being greater than a second threshold, second CSI including information indicating the quality of the second CSI-RS resource set and a CSI-RS resource set indicator associated with the second CSI-RS resource set. For example, the one or more second measurements may be based on (e.g., performed using) the second CSI-RS resource set and the 2nd scrambling ID.

In certain representative embodiments, a WTRU may receive configuration information indicating a plurality of CSI-RS resources. The WTRU may determine one or more TCI states associated with the plurality of CSI-RS resources based on one or more TCI states associated with one or more control resource sets (CORESETs) and/or search spaces for the plurality of CSI-RS resources. The WTRU may perform measurements of the plurality of CSI-RS resources using the determined one or more TCI states. The WTRU may report CSI including information indicating a quality of the plurality of CSI-RS resources based on the measurements.

In certain representative embodiments, a WTRU may receive configuration information indicating a first CSI reporting resource and a second CSI reporting resource. The WTRU may report CSI including information indicating a quality of one or more first CSI-RS resources using the first CSI reporting resource. The WTRU may send, based on the quality of the one or more first CSI-RS resources being less than or equal to a threshold, a physical uplink control channel (PUCCH) transmission using the second CSI reporting resource. The PUCCH transmission may include information indicating a quality of one or more second CSI-RS resources. For example, the PUCCH transmission may be sent using (1) one or more WTRU-specific sequences based on an identifier associated with the second CSI resource and/or (2) a WTRU-specific hopping pattern based on the identifier associated with the second CSI reporting resource.

In certain representative embodiments, a WTRU may receive CSI reporting information indicating a first CSI-RS resource set. The WTRU may perform first measurements using the first CSI-RS resource set. The WTRU may report CSI including information indicating a quality of the first CSI-RS resource set based on the first measurements. For example, the reported CSI may include information indicating a preferred reporting mode of the WTRU.

In certain representative embodiments, a WTRU may receive configuration information indicating a first RS resource set and a second RS resource set. The WTRU may determine a RS resource set from the first RS resource set and the second RS resource set. The WTRU may perform measurements using the determined RS resource set and a scrambling ID associated with the determined RS resource set. The WTRU may report CSI including a quality of the determined RS resource set based on the measurements. The reporting of the CSI may use a contention-based reporting resource or a non-contention-based reporting resource.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example RAN and examples of beam groups;

FIG. 3 is a chart illustrating available frequencies between 52.6 and 71 GHz by global region;

FIG. 4 is a chart illustrating available licensed (L) frequencies between 71 and 100 GHz by global region;

FIG. 5 is a chart illustrating example physical uplink control channel (PUCCH) formats and associated information;

FIG. 6 is a chart illustrating an example of block code for encoding 1-bit of information;

FIG. 7 is a chart illustrating an example of block code for encoding 2-bits of information;

FIG. 8 is a chart illustrating an example of basis sequences of a (32, K) Reed-Muller code for encoding information;

FIG. 9 is a procedural diagram illustrating an example procedure for reporting CSI for multiple CSI-RS resource sets;

FIG. 10 is a procedural diagram illustrating an example procedure for reporting CSI for multiple CSI-RS resources using determined TCI states;

FIG. 11 is a procedural diagram illustrating an example procedure for receiving CSI using WTRU-determined TCI states;

FIG. 12 is a procedural diagram illustrating an example procedure for reporting CSI using a physical uplink control channel (PUCCH) transmission;

FIG. 13 is a procedural diagram illustrating an example procedure for receiving CSI using a physical uplink control channel (PUCCH) transmission;

FIG. 14 is a procedural diagram illustrating an example procedure for reporting CSI and a preferred reporting mode of a WTRU;

FIG. 15 is a procedural diagram illustrating an example procedure for receiving CSI and a preferred reporting mode of a WTRU;

FIG. 16 is a procedural diagram illustrating an example procedure for reporting CSI; and

FIG. 17 is a procedural diagram illustrating an example procedure for receiving CSI.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

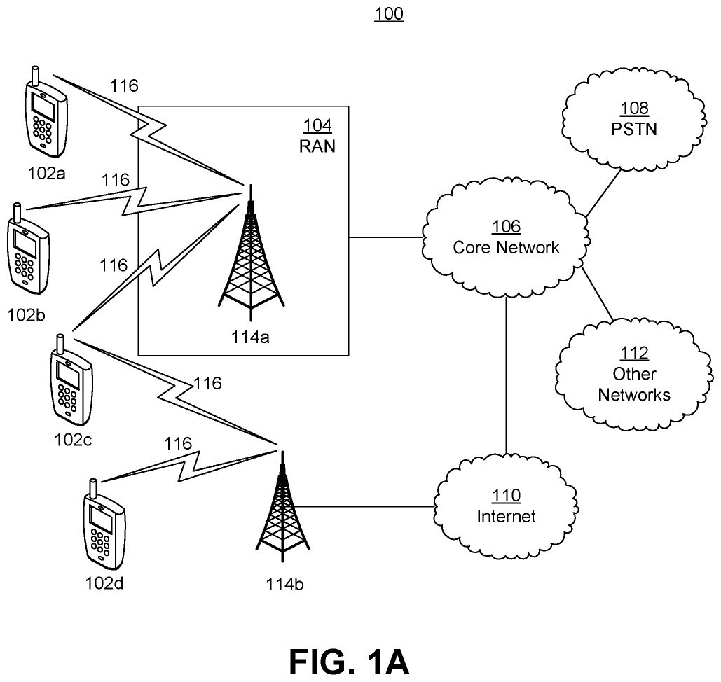

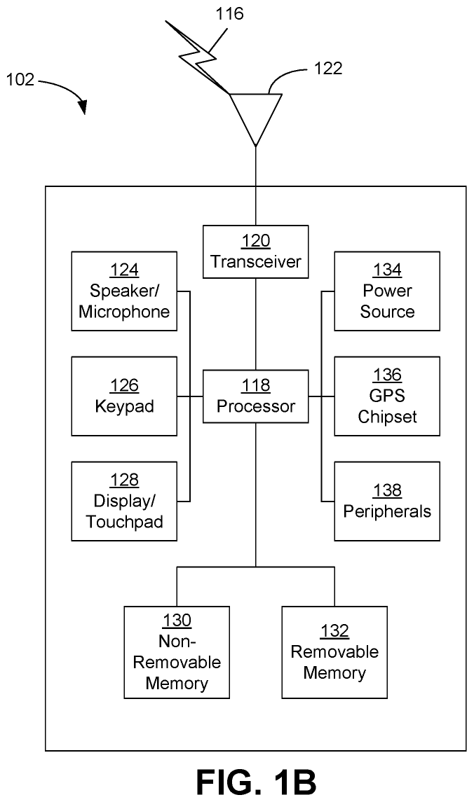

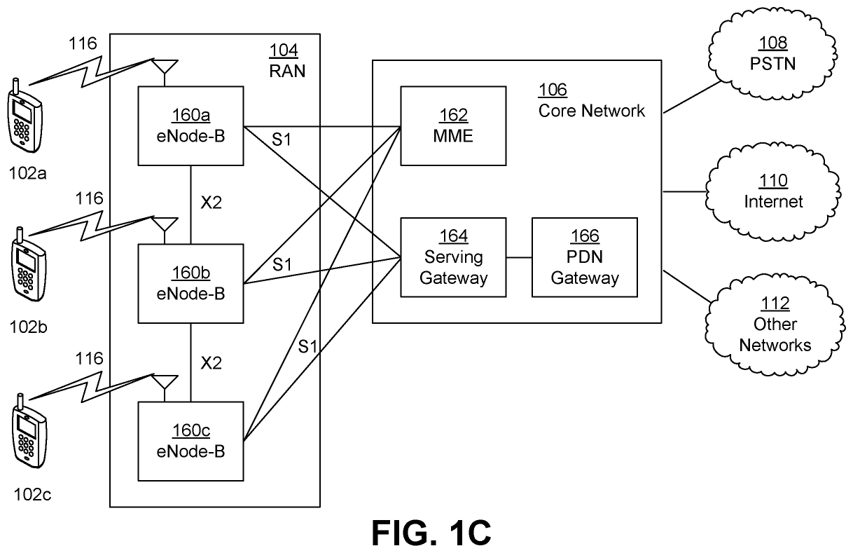

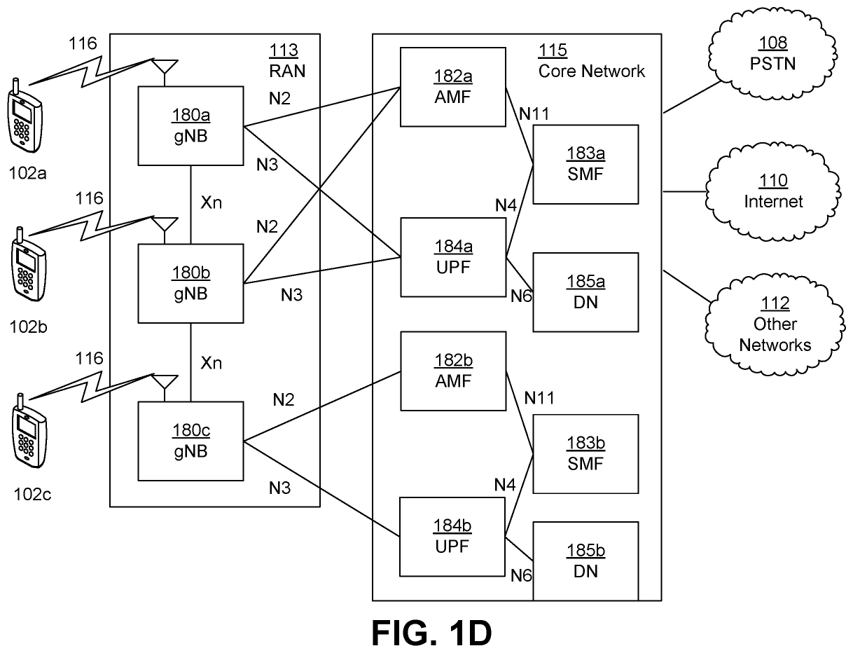

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

The following abbreviations and acronyms may be used throughout the description:
Δf Sub-carrier spacing
gNB NR NodeB
AP Aperiodic
BFR Beam Failure Recovery
BFD-RS Beam Failure Detection-Reference Signal
BLER Block Error Rate
BWP Bandwidth Part
CA Carrier Aggregation
CB Contention-Based (e.g. access, channel, resource)
CDM Code Division Multiplexing
CG Cell Group
CoMP Coordinated Multi-Point transmission/reception
CP Cyclic Prefix
CPE Common Phase Error
CP-OFDM Conventional OFDM (relying on cyclic prefix)
CQI Channel Quality Indicator
CN Core Network (e.g. LTE packet core or NR core)
CRC Cyclic Redundancy Check
CSI Channel State Information
CSI-RS Channel State Information-Reference Signal
CU Central Unit
D2D Device to Device transmissions (e.g. LTE Sidelink)
DC Dual Connectivity
DCI Downlink Control Information
DL Downlink
DM-RS Demodulation Reference Signal
DRB Data Radio Bearer
DU Distributed Unit
EN-DC E-UTRA-NR Dual Connectivity
EPC Evolved Packet Core
FD-CDM Frequency Domain-Code Division Multiplexing
FDD Frequency Division Duplexing
FDM Frequency Division Multiplexing
ICI Inter-Cell Interference
ICIC Inter-Cell Interference Cancellation
ID Identifier
IP Internet Protocol
LBT Listen-Before-Talk
LCH Logical Channel
LCID Logical Channel Identity
LCP Logical Channel Prioritization
LLC Low Latency Communications
LTE Long Term Evolution e.g. from 3GPP LTE R8 and up
MAC Medium Access Control
MAC CE Medium Access Control Element
NACK Negative ACK
MBMS Multimedia Broadcast Multicast System
MCG Master Cell Group
MCS Modulation and Coding Scheme
MIMO Multiple Input Multiple Output
MTC Machine-Type Communications
MR-DC Multi-RAT Dual Connectivity
NAS Non-Access Stratum
NCB-RS New candidate beam-Reference Signal
NE-DC NR-RAN-E-UTRA Dual Connectivity
NR New Radio
NR-DC Dual Connectivity with
OFDM Orthogonal Frequency-Division Multiplexing
OOB Out-Of-Band (emissions)
P_{cmax} Total available UE power in a given transmission interval
Pcell Primary cell of Master Cell Group
PCG Primary Cell Group
PDU Protocol Data Unit
PER Packet Error Rate
PF PUCCH Format
PHY Physical Layer
PLMN Public Land Mobile Network
PLR Packet Loss Rate
PDCCH Physical Downlink Control Channel
PDSCH Physical Downlink Shared Channel
PUCCH Physical Uplink Control Channel
PUSCH Physical Uplink Shared Channel
PRACH Physical Random Access Channel
PRB Physical Resource Block
PRS Positioning Reference Signal
Pscell Primary cell of a Secondary cell group
PSS Primary Synchronization Signal
PT-RS Phase Tracking-Reference Signal
QoS Quality of Service (from the physical layer perspective)
RAB Radio Access Bearer
RAN PA Radio Access Network Paging Area
RACH Random Access Channel (or procedure)
RAR Random Access Response
RAT Radio Access Technology
RB Resource Block
RCU Radio access network Central Unit
RF Radio Front end
RE Resource Element
RLF Radio Link Failure
RLM Radio Link Monitoring
RNTI Radio Network Identifier
ROM Read-Only Mode (for MBMS)
RRC Radio Resource Control
RRM Radio Resource Management
RS Reference Signal
RTT Round-Trip Time
SCG Secondary Cell Group
SCMA Single Carrier Multiple Access
SCS Sub-Carrier Spacing
SDU Service Data Unit
SOM Spectrum Operation Mode
SP Semi-persistent
SpCell Primary cell of a master or secondary cell group.
SRB Signaling Radio Bearer
SS Synchronization Signal
SR Scheduling Request
SRS Sounding Reference Signal
SSS Secondary Synchronization Signal
SUL Supplementary UpLink
SWG Switching Gap (in a self-contained subframe)
TB Transport Block
TBS Transport Block Size
TCI Transmission Configuration Index
TDD Time-Division Duplexing
TDM Time-Division Multiplexing
TI Time Interval (in integer multiple of one or more symbols)
TTI Transmission Time Interval (in integer multiple of one or more symbols)
TRP Transmission/Reception Point
TRPG Transmission/Reception Point Group
TRS Tracking Reference Signal
TRx Transceiver
UL Uplink
URC Ultra-Reliable Communications
URLLC Ultra-Reliable and Low Latency Communications
V2X Vehicular communications
WLAN Wireless Local Area Networks and related technologies (IEEE 802.xx domain)

In certain representative embodiments, procedures for (e.g., non-orthogonal) CSI-RS transmission, measurement, and/or reporting thereof may be performed. In certain representative embodiments, one or more CSI-RS resource sets (e.g., for multiple beam groups) may be shared. In certain representative embodiments, contention based CSI reporting may be performed (e.g., by a WTRU 102).

In certain representative embodiments, one or more CSI-RS resource sets (e.g., for multiple beam groups) may be shared. For example, neighboring (e.g., spatially neighboring) beam groups, such as which share a same CSI-RS resource set, may use a separate CSI-RS resource ID for each beam group, respectively. A first beam group (e.g., group #1) associated with a first CSI-RS ID and a second beam group (e.g., group #3) associated with a second CSI-RS ID may share a CSI-RS resource set.

In certain representative embodiments, a WTRU 102 may (e.g., autonomously) change CSI-RS resource sets and/or CSI-RS IDs used for beam measurement. For example, a WTRU 102 may be configured with two CSI-RS resource sets and/or two CSI measurement configurations. The WTRU 102 may perform more frequent measurement of a CSI-RS resource set for CSI reporting (e.g., 1st CSI-RS resource set) and/or associated with a first CSI-RS ID. The WTRU 102 may perform less frequent measurement for a CSI-RS resource set for a candidate beam group (e.g., 1st CSI-RS resource set) and/or associated with a second CSI-RS ID. As another example, the WTRU 102 may perform less frequent measurement for a CSI-RS resource set for a candidate beam group (e.g., 2nd CSI-RS resource set) and/or associated with two CSI-RS IDs.

For example, a WTRU 102 may change a CSI-RS resource set for CSI measurement from a 1st CSI-RS resource set and/or 1st CSI-RS ID to a 2nd CSI-RS resource set and/or 2nd CSI-RS ID on condition one or more conditions are met, such as (1) where a quality (e.g., RSRP) of the 1st set is greater than or equal to a threshold, (2) a quality of the 1st set with the 1st CSI-RS ID is greater than or equal to a quality of the 1st set with the 2nd CSI-RS ID, and/or (3) a quality of the 2nd set (e.g., an average and/or best value) is greater than a quality of the 1st set.

In certain representative embodiments, CSI-RS (e.g., non-orthogonal) transmission may be based on multiple TRPs. For example, multiple beam groups may (e.g., always) be transmitted. For example, multiple measurement configurations may be configured (e.g., at a WTRU 102). A first configuration may include frequent measurement and/or a second configuration may include (e.g., less) frequent measurement. A first configuration (e.g., periodicity and/or offset) may be scaled using a second configuration (e.g., periodicity and/or offset values).

In certain representative embodiments, CSI-RS (e.g., non-orthogonal) transmission may be based on a single TRP. For example, transmitting beam groups may be (e.g., dynamically) changed in one resource set. For example, the changing of a resource set may be based on handshaking and/or other confirmation.

In certain representative embodiments, a base station (e.g., gNB) may perform confirmation for a CSI-RS change (e.g., initiated or determined at a WTRU 102). For example, one or more CORESETs may be configured. For one CORESET, a WTRU 102 may receive the confirmation (e.g., indicated in a PDCCH transmission) via the CORESET. For two or more CORESETs, a WTRU 102 may receive the confirmation via an associated CORESET with a new and/or updated CSI-RS for measurement.

In certain representative embodiments, a QCL Type-D determination may be associated with (e.g., non-orthogonal) CSI-RS transmission. For example, one or more QCL Type-D configurations may be configured and/or associated with a CSI-RS resource. A WTRU 102 may be configured with one or more QCL Type-D configuration in or for one CSI-RS resource. For example, a WTRU 102 may apply an associated QCL Type-D configuration with a determined scrambling ID for a CSI-RS resource. For example, no QCL Type-D configuration may be configured and/or associated with a CSI-RS resource. The CSI resource may be used as a source RS for QCL Type-D for other signals and/or other channels.

In certain representative embodiments, a QCL Type-D update may be configured and/or associated with a CSI-RS for CSI reporting. For example, one CSI-RS resource and/or resource set may be configured for CSI reporting. The CSI-RS resource and/or resource set may be associated with a determined CSI-RS resource and/or resource set based on WTRU beam reporting. For example, a source RS of QCL Type-D assumption for a CSI-RS for CSI reporting may be the determined CSI-RS resource and/or resource in the UE beam reporting.

In certain representative embodiments, beam reporting with a (e.g., new) CSI-RS resource set may include one or more of following: (1) a (e.g., new) CSI-RS resource set indicator, (2) a (e.g., new) CSI-RS resource ID, (3) a CSI measurement reset indication for a previously measured resource set with previous CSI-RS ID, and/or (4) other CSI parameters (e.g., CRI, SSBRI, L1-RSRP, L1-SINR or the like). For example, a WTRU 102 may explicitly or implicitly indicate the measurement and/or reporting from a 2nd CSI-RS resource set to a gNB. An indicator, such as an explicit ID or toggle, may be used. For example, a CSI-RS ID in an indicated CSI-RS resource set may be explicitly or implicitly indicated to the gNB. An indicator, such as an explicit ID or toggle, may be used.

In certain representative embodiments, contention based CSI reporting may be performed.

In certain representative embodiments, contention based CSI reporting can be performed when conditions support such reporting. For example, a WTRU may transmit a PUCCH transmission for or including CSI reporting in a common PUCCH resource, such as when (e.g., only when) one or more trigger conditions are satisfied.

In certain representative embodiments, a dynamic reporting mode indication may be used in conjunction with contention based CSI reporting. For example, a base station (e.g., a gNB) may indicate a mode for regular CSI (e.g., periodic and/or aperiodic) reporting and/or indicate a WTRU trigger based CSI (e.g., WTRU specific, group specific and/or or cell specific signal) reporting. For example, a base station (e.g., gNB) may activate a mode for trigger based CSI reporting for efficient operation (e.g., in general cases). For example, a base station (e.g., gNB) may activate a mode for (e.g., non-trigger based) CSI reporting, such as for high traffic cases (e.g., concerts, stadiums and the like). A WTRU 102 may recommend a preferred CSI mode via CSI reporting. For example, a preferred CSI mode may be indicated by a reporting mode indicator (RMI). A RMI may be included in a (e.g., regular or non-triggered) CSI report.

In certain representative embodiments, contention based CSI reporting may be based on a PUCCH (e.g., resources and/or transmission). A WTRU identification may be needed to identify the WTRU 102 transmitting a contention based CSI report based on an identifier, such as a configuration of a WTRU ID and/or a beam group ID. For example, scrambling and/or WTRU specific sequences for PUCCH DMRS with a configured ID may be used, such as for formats other than PUCCH format 0 (e.g., due to absence of PUCCH DMRS). For example, masking a CRC with a configured ID may be used. For example, the masking may be WTRU specific. Applicability of masking may depend on a PUCCH transmission payload size. For example, no CRC bit may be supported if the payload size satisfies: payload size 11 bits. For example, a 6 bit CRC may be supported if the payload size satisfies: 12 bits payload size 19 bits. For example, an 11 bit CRC may be supported if the payload size satisfies: 20 bits payload size. For example, CRC attachment for contention based CSI reporting may depend on whether such attachment is supported. For example, where a payload size of the PUCCH is small (e.g., below a threshold), CRC may be added or a bit size may be increased.

For example, WTRU-specific reserved sequences and/or cyclic shifts (e.g., for ZC sequences) and/or scrambling may be used. A same scrambling format or type may be applied to PUCCH formats 3 and 4. A CSI reporting RNTI may be used. For example, a WTRU-specific hopping pattern and/or group-specific hopping pattern may be used. For example, an identifier with an associated PRACH transmission and/or an associated PUSCH resource with a configured grant may be used. A different identifier may be used that is associated with two-step RACH and/or PUSCH transmissions. For example, different methods or identifiers may be used based on a WTRU state, such as whether to use a first channel (and/or format) or a second channel (and/or format) for a transmission. For example, different methods or identifiers may be used depending on a WTRU status (e.g., synchronized with the RAN or not) whether a transmission uses (e.g., is to use) PRACH or PUCCH (e.g., to send a SR), and/or whether a transmission (e.g., a SR) uses a PUCCH format 3 or a PUCCH format 4. For example, a SR signal or similar signal may be used to indicate to activate one or more CSI reporting configurations and/or RS configurations for CSI reporting. For example, a two-step RACH procedure may be used for contention based CSI reporting.

In certain representative embodiments, contention based CSI reporting may be triggered by one or more events. For example, contention based CSI reporting may be triggered on condition that a relationship (e.g., difference) between a (e.g., newly) measured quality and a reported quality is greater than or equal to a threshold. For example, contention based CSI reporting may be triggered on condition that a relationship (e.g., difference) between a (e.g., new) best beam (and/or beam group) and a reported best beam (and/or beam group) is greater than or equal to a threshold. For example, contention based CSI reporting may be triggered on condition that a CSI-RS resource set indicator and/or a CSI-RS ID indicator can be reported. For example, contention based CSI reporting may be triggered on condition that a WTRU UL transmission power associated with recent transmissions and/or CSI reports is greater than or equal to a threshold. For example, contention based CSI reporting may be triggered based on an association with a TCI state indication. For example, contention based CSI reporting may be triggered based on an association with preconfigured and/or defined activated TCI states, such as based on a reported CSI-RS resource set. For example, contention based CSI reporting may be triggered on condition that one bit is used and/or configured to confirm a WTRU report for TCI state activation. For example, contention based CSI reporting may be triggered on condition that one bit is used and/or configured to confirm a WTRU report for a best beam for TCI state indication. Other events may also trigger contention based CSI reporting other than measurements, such as traffic, data arrival (e.g., associated with the beam group), priority (e.g., traffic type), unlicensed frequency use (e.g., where a missed number of LBTs is greater than a threshold).

### Overview

### NR THz—Efficient CSI Reporting in Higher Frequencies

CSI and beam reporting may be a (e.g., essential) feature to finding an optimized beam and support efficient transmission and reception of PDSCH. Traditional CSI acquisition methods may not be efficient for THz band operations. Time and/or frequency overhead may increase as the number of antennas increases. The increased number of antennas may lead to an increased number of beams. The increased number of beams may require more RS resources. The increased number of antennas may also increase measurement delays and CSI aging. For example, different analog beams may be measured with a TDM approach which can lead to more latency. THz communications may be more sensitive to CSI errors due to narrow beams, and faster beam application methods may support improvements to THz band communications.

In certain representative embodiments, a WTRU may support beam measurement and CSI reporting using minimal (e.g., time and/or frequency) resources and/or minimal added latency.

In certain representative embodiments, procedures for (e.g., non-orthogonal) CSI-RS transmission, measurement, and/or reporting thereof may be performed. In certain representative embodiments, one or more CSI-RS resource sets (e.g., for multiple beam groups) may be shared. In certain representative embodiments, contention based CSI reporting may be performed (e.g., by a WTRU 102).

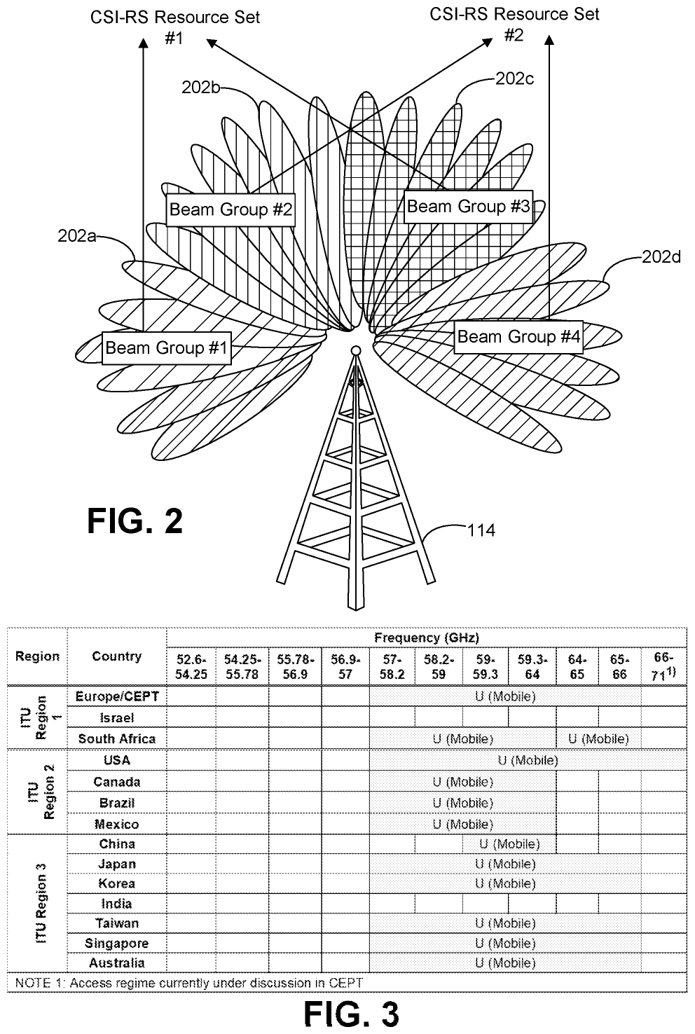

FIG. 2 is a system diagram illustrating an example RAN and examples of beam groups. As shown in FIG. 2, a RAN 104, 113 may use (e.g., transmit) a plurality of beams which may be transmitted by a base station 114. For example, the beams 202a, 202b, 202c, 202d and so forth may be arranged in a plurality of beam groups, such as beam group #1, beam group #2, beam group #3, and/or beam group #4. For example, each beam group may include a subset of the plurality of beams. Beam group #1 may be associated as (e.g., identified as) CSI-RS resource set #1. Beam group #2 may be associated as (e.g., identified as) CSI-RS resource set #2. Beam group #3 may be associated as (e.g., identified as) CSI-RS resource set #1. Beam group #4 may be associated as (e.g., identified as) CSI-RS resource set #2. For example, each of the beam groups may include multiple beams (e.g., a subset of beams). In FIG. 2, each beam group is shown to include six beams. For example, any of the beams and/or beam groups may include frequencies between 71 and 100 GHz.

In certain representative embodiments, one or more CSI-RS resource sets (e.g., for multiple beam groups) may be shared. For example, neighboring (e.g., spatially neighboring) beam groups, such as which share a same CSI-RS resource set, may use a separate CSI-RS resource ID for each beam group, respectively. A first beam group (e.g., group #1) associated with a first CSI-RS ID and a second beam group (e.g., group #3) associated with a second CSI-RS ID may share a CSI-RS resource set.

In certain representative embodiments, a WTRU 102 may (e.g., autonomously) change CSI-RS resource sets and/or CSI-RS IDs used for beam measurement. For example, a WTRU 102 may be configured with two CSI-RS resource sets and/or two CSI measurement configurations. The WTRU 102 may perform more frequent measurement of a CSI-RS resource set for CSI reporting (e.g., 1st CSI-RS resource set) and/or associated with a first CSI-RS ID. The WTRU 102 may perform less frequent measurement for a CSI-RS resource set for a candidate beam group (e.g., 1st CSI-RS resource set) and/or associated with a second CSI-RS ID. As another example, the WTRU 102 may perform less frequent measurement for a CSI-RS resource set for a candidate beam group (e.g., 2nd CSI-RS resource set) and/or associated with two CSI-RS IDs.

For example, a WTRU 102 may change a CSI-RS resource set for CSI measurement from a 1st CSI-RS resource set and/or 1st CSI-RS ID to a 2nd CSI-RS resource set and/or 2nd CSI-RS ID on condition one or more conditions are met, such as (1) where a quality (e.g., RSRP) of the 1st set is greater than or equal to a threshold, (2) a quality of the 1st set with the 1st CSI-RS ID is greater than or equal to a quality of the 1st set with the 2nd CSI-RS ID, and/or (3) a quality of the 2nd set (e.g., an average and/or best value) is greater than a quality of the 1st set.

In certain representative embodiments, CSI-RS (e.g., non-orthogonal) transmission may be based on multiple TRPs. For example, multiple beam groups may (e.g., always) be transmitted. For example, multiple measurement configurations may be configured (e.g., at a WTRU 102). A first configuration may include frequent measurement and/or a second configuration may include (e.g., less) frequent measurement. A first configuration (e.g., periodicity and/or offset) may be scaled using a second configuration (e.g., periodicity and/or offset values).

In certain representative embodiments, CSI-RS (e.g., non-orthogonal) transmission may be based on a single TRP. For example, transmitting beam groups may be (e.g., dynamically) changed in one resource set. For example, the changing of a resource set may be based on handshaking and/or other confirmation.

In certain representative embodiments, a base station (e.g., gNB) may perform confirmation for a CSI-RS change (e.g., initiated or determined at a WTRU 102). For example, one or more CORESETs may be configured. For one CORESET, a WTRU 102 may receive the confirmation (e.g., indicated in a PDCCH transmission) via the CORESET. For two or more CORESETs, a WTRU 102 may receive the confirmation via an associated CORESET with a new and/or updated CSI-RS for measurement.

In certain representative embodiments, a QCL Type-D determination may be associated with (e.g., non-orthogonal) CSI-RS transmission. For example, one or more QCL Type-D configurations may be configured and/or associated with a CSI-RS resource. A WTRU 102 may be configured with one or more QCL Type-D configuration in or for one CSI-RS resource. For example, a WTRU 102 may apply an associated QCL Type-D configuration with a determined scrambling ID for a CSI-RS resource. For example, no QCL Type-D configuration may be configured and/or associated with a CSI-RS resource. The CSI resource may be used as a source RS for QCL Type-D for other signals and/or other channels.

In certain representative embodiments, a QCL Type-D update may be configured and/or associated with a CSI-RS for CSI reporting. For example, one CSI-RS resource and/or resource set may be configured for CSI reporting. The CSI-RS resource and/or resource set may be associated with a determined CSI-RS resource and/or resource set based on WTRU beam reporting. For example, a source RS of QCL Type-D assumption for a CSI-RS for CSI reporting may be the determined CSI-RS resource and/or resource in the UE beam reporting.

In certain representative embodiments, beam reporting with a (e.g., new) CSI-RS resource set may include one or more of following: (1) a (e.g., new) CSI-RS resource set indicator, (2) a (e.g., new) CSI-RS resource ID, (3) a CSI measurement reset indication for a previously measured resource set with previous CSI-RS ID, and/or (4) other CSI parameters (e.g., CRI, SSBRI, L1-RSRP, L1-SINR or the like). For example, a WTRU 102 may explicitly or implicitly indicate the measurement and/or reporting from a 2nd CSI-RS resource set to a gNB. An indicator, such as an explicit ID or toggle, may be used. For example, a CSI-RS ID in an indicated CSI-RS resource set may be explicitly or implicitly indicated to the gNB. An indicator, such as an explicit ID or toggle, may be used.

In certain representative embodiments, contention based CSI reporting may be performed.

In certain representative embodiments, contention based CSI reporting can be performed when conditions support such reporting. For example, a WTRU may transmit a PUCCH transmission for or including CSI reporting in a common PUCCH resource, such as when (e.g., only when) one or more trigger conditions are satisfied.

In certain representative embodiments, a dynamic reporting mode indication may be used in conjunction with contention based CSI reporting. For example, a base station (e.g., a gNB) may indicate a mode for regular CSI (e.g., periodic and/or aperiodic) reporting and/or indicate a WTRU trigger based CSI (e.g., WTRU specific, group specific and/or or cell specific signal) reporting. For example, a base station (e.g., gNB) may activate a mode for trigger based CSI reporting for efficient operation (e.g., in general cases). For example, a base station (e.g., gNB) may activate a mode for (e.g., non-trigger based) CSI reporting, such as for high traffic cases (e.g., concerts, stadiums and the like). A WTRU 102 may recommend a preferred CSI mode via CSI reporting. For example, a preferred CSI mode may be indicated by a reporting mode indicator (RMI). A RMI may be included in a (e.g., regular or non-triggered) CSI report.

In certain representative embodiments, contention based CSI reporting may be based on a PUCCH (e.g., resources and/or transmission). A WTRU identification may be needed to identify the WTRU 102 transmitting a contention based CSI report based on an identifier, such as a configuration of a WTRU ID and/or a beam group ID. For example, scrambling and/or WTRU specific sequences for PUCCH DMRS with a configured ID may be used, such as for formats other than PUCCH format 0 (e.g., due to absence of PUCCH DMRS). For example, masking a CRC with a configured ID may be used. For example, the masking may be WTRU specific. Applicability of masking may depend on a PUCCH transmission payload size. For example, no CRC bit may be supported if the payload size satisfies: payload size 11 bits. For example, a 6 bit CRC may be supported if the payload size satisfies: 12 bits payload size 19 bits. For example, an 11 bit CRC may be supported if the payload size satisfies: 20 bits payload size. For example, CRC attachment for contention based CSI reporting may depend on whether such attachment is supported. For example, where a payload size of the PUCCH is small (e.g., below a threshold), CRC may be added or a bit size may be increased.

For example, WTRU-specific reserved sequences and/or cyclic shifts (e.g., for ZC sequences) and/or scrambling may be used. A same scrambling format or type may be applied to PUCCH formats 3 and 4. A CSI reporting RNTI may be used. For example, a WTRU-specific hopping pattern and/or group-specific hopping pattern may be used. For example, an identifier with an associated PRACH transmission and/or an associated PUSCH resource with a configured grant may be used. A different identifier may be used that is associated with two-step RACH and/or PUSCH transmissions. For example, different methods or identifiers may be used based on a WTRU state, such as whether to use PRACH or PUCCH (SR)?SR+PUCCH3/4?. For example, a SR signal or similar signal may be used to indicate to activate one or more CSI reporting configurations and/or RS configurations for CSI reporting. For example, a two-step RACH procedure may be used for contention based CSI reporting.

In certain representative embodiments, contention based CSI reporting may be triggered by one or more events. For example, contention based CSI reporting may be triggered on condition that a relationship (e.g., difference) between a (e.g., newly) measured quality and a reported quality is greater than or equal to a threshold. For example, contention based CSI reporting may be triggered on condition that a relationship (e.g., difference) between a (e.g., new) best beam (and/or beam group) and a reported best beam (and/or beam group) is greater than or equal to a threshold. For example, contention based CSI reporting may be triggered on condition that a CSI-RS resource set indicator and/or a CSI-RS ID indicator can be reported. For example, contention based CSI reporting may be triggered on condition that a WTRU UL transmission power associated with recent transmissions and/or CSI reports is greater than or equal to a threshold. For example, contention based CSI reporting may be triggered based on an association with a TCI state indication. For example, contention based CSI reporting may be triggered based on an association with preconfigured and/or defined activated TCI states, such as based on a reported CSI-RS resource set. For example, contention based CSI reporting may be triggered on condition that one bit is used and/or configured to confirm a WTRU report for TCI state activation. For example, contention based CSI reporting may be triggered on condition that one bit is used and/or configured to confirm a WTRU report for a best beam for TCI state indication. Other events may also trigger contention based CSI reporting other than measurements, such as traffic, data arrival (e.g., associated with the beam group), priority (e.g., traffic type), unlicensed frequency use (e.g., where a missed number of LBTs is greater than a threshold).

In the 3GPP RAN #80 meeting, a new RAN study item on New Radio (NR) beyond 52.6 GHz was agreed upon. According to a survey of the study item 3GPP TR 38.807, “Study on requirements for NR beyond 52.6 GHz”, v16.0.0, there is a minimum 5 GHz of spectrum available globally, between 57 to 64 GHz, for unlicensed operation and in some countries up to 14 GHz of spectrum, between 57 and 71 GHz, for unlicensed operation. Additionally, the survey has identified minimum of 10 GHz of spectrum available globally, between 71 to 76 GHz and 81 to 86 GHz, for licensed operation and in some countries up to 18 GHz of spectrum available, between 71 and 114.25 GHz, for licensed operation. While frequency ranges above 52.6 GHz potentially contain larger spectrum allocations and larger bandwidths that are not available for bands lower than 52.6 GHz, however, physical layer channels of NR were designed to be optimized for uses under 52.6 GHz.

FIG. 3 is a chart illustrating available unlicensed (U) frequencies between 52.6 and 71 GHz by global region.

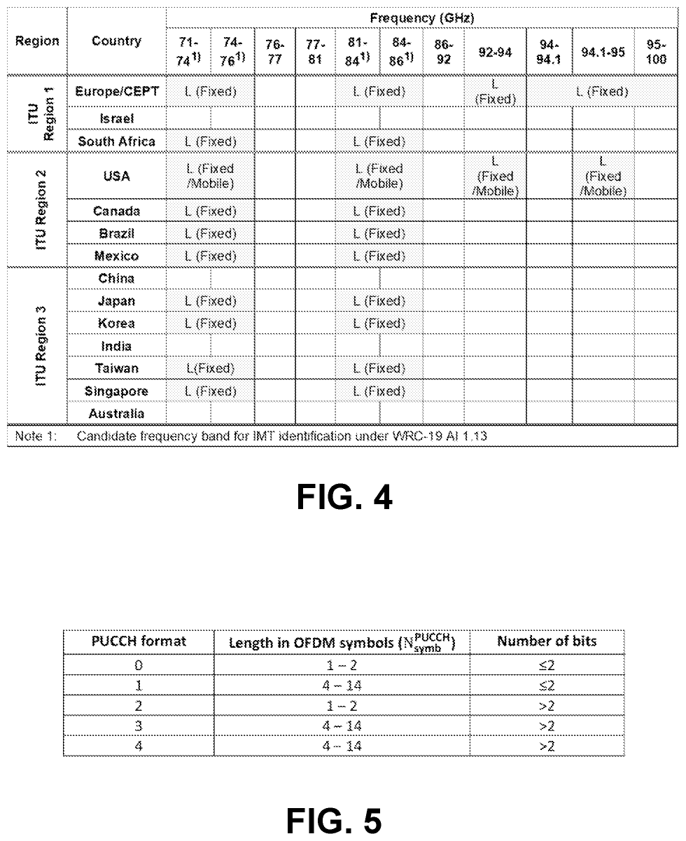

FIG. 4 is a chart illustrating available licensed (L) frequencies between 71 and 100 GHz by global region.

To enable and optimize NR systems, the frequencies above 52.6 GHz are faced with more difficult challenges, such as higher phase noise, extreme propagation loss due to high atmospheric absorption, lower power amplifier efficiency, and strong power spectral density regulatory requirements, as compared to lower frequency bands.

Channel State Information (CSI) and beam reporting may serve as a (e.g., essential) feature to find an optimized beam and/or to support efficient transmission and reception (e.g., of PDSCH transmissions). Lower frequency CSI acquisition methods may not be efficient for THz band operation. In higher frequency bands, the number of antennas may increase with an aims toward overcoming increased pathloss and/or maintaining cell coverage. As the number of antennas increases, a number of beams increases as well, therefore a WTRU 102 may require an increased number of reference signal (RS) resources and added measurement delay. This issue may be more critical to higher frequencies as different analog beams may not be measured simultaneously. In addition, the increased number of antennas and/or beams may require more narrow beams and/or wireless communication in higher frequencies may be more sensitive to CSI error, therefore faster beam application methods may be needed for higher frequency (e.g., THz band) operation.

As described in greater detail below, certain representative embodiments may efficiently utilize RS transmission and CSI reporting. Certain representative embodiments may enable non-orthogonal RS transmission/measurement and corresponding CSI reporting. In a representative embodiment, a base station (e.g., gNB) may transmit multiple RSs (e.g., which are not orthogonal to each other) to reduce time/frequency resources for RS transmission. A WTRU 102 may measure one or more of the multiple RSs for CSI reporting. For example, the base station (e.g., gNB) may transmit a first RS (e.g., a desired signal for WTRU 102) and a second RS (e.g., a non-orthogonal signal to the desired signal) which are not orthogonal. The WTRU 102 may measure the first RS without high interference from the second RS due to a narrow beamwidth and a high pathloss in higher (e.g., THz) frequencies. Certain representative embodiments may enable contention based CSI reporting with configured (e.g., required) CSI parameters. In a representative embodiment a base station (e.g., gNB) may configure one or more triggering conditions and one or more CSI reporting resources, which may be shared among multiple WTRUs 102, to a WTRU 102. The WTRU 102 may transmit a CSI report in the CSI reporting resources on condition that the one or more configured triggering conditions are satisfied. In addition, another WTRU 102 may transmit another CSI report in the (e.g., same or overlapping) CSI reporting resources as well. For example, a first WTRU 102 may transmit a first CSI report in the CSI reporting resource and a second WTRU 102 may transmit a second CSI report in the first CSI reporting resource. The base station (e.g., gNB) may successfully receive and decode the first CSI report and the second CSI report with different beams due to a narrow beam width and a higher pathloss in higher (e.g., THz) frequencies.

### Beams, Spatial Relations, and Beam Indicators

As described herein, a WTRU 102 may transmit or receive a physical channel and/or reference signal according to at least one spatial domain filter. The term “beam” may be used to refer to a spatial domain filter. Beam and spatial domain filter may be used interchangeably herein.

As described herein, a WTRU 102 may transmit a physical channel and/or signal using a same spatial domain filter as the spatial domain filter used for receiving an RS (e.g., CSI-RS) and/or a SS block. The WTRU transmission may be referred to as “target”, and the received RS and/or SS block may be referred to as a “reference” or a “source.” For example, the WTRU 102 may be said to transmit the target physical channel and/or signal according to a spatial relation with a reference to the source (e.g., the RS and/or SS block).

As described herein, a WTRU 102 may transmit a first physical channel and/or signal according to a same spatial domain filter as the spatial domain filter used for transmitting a second physical channel and/or signal. The first and second transmissions may be referred to as a “target” and a “reference” (or “source”), respectively. For example, the WTRU 102 may transmit a first (e.g., target) physical channel and/or signal according to a spatial relation with a reference to the second (e.g., reference) physical channel and/or signal.

In certain representative embodiments, a spatial relation may be implicit, configured by RRC, and/or signaled by MAC CE or DCI. For example, a WTRU 102 may implicitly transmit a PUSCH transmission and DM-RS(s) of PUSCH according to a same spatial domain filter as an SRS indicated by an SRI indicated in DCI and/or configured by RRC. In another example, a spatial relation may be configured by RRC for an SRS resource indicator (SRI) and/or signaled by MAC CE for a PUCCH transmission. As described herein a spatial relation may also be referred to as a “beam indication.”

As described herein, a WTRU 102 may receive a first (e.g., target) downlink channel and/or signal according to a same spatial domain filter or spatial reception parameter as a second (e.g., reference) downlink channel and/or signal. For example, an association may exist between a physical channel, such as PDCCH or PDSCH, and its respective DM-RS(s). At least when the first and second signals are reference signals, such an association may exist when the WTRU 102 is configured with a quasi-colocation (QCL) assumption type D between corresponding antenna ports. In certain representative embodiments, an association may be configured as a TCI state. A WTRU 102 may receive an indication of an association between a CSI-RS (and/or SS block) and a DM-RS by an index to a set of TCI states configured by RRC and/or signaled by MAC CE. As described herein, such an indication may also be referred to as a “beam indication.”

### Configurations for CSI Measurement and Reporting

As described herein, a reference signal (RS) may be interchangeably used with and/or refer to any of the following: sounding reference signal (SRS), channel state information reference signal (CSI-RS), demodulation reference signal (DM-RS), phase tracking reference signal (PT-RS), and/or synchronization signal block (SSB).

As described herein, a channel and/or transmission may be interchangeably used with and/or refer to any of the following: PDCCH, PDSCH, PUCCH, PUSCH, and/or PRACH.

As described herein, a RS resource set may be interchangeably used with and/or refer to a RS resource and/or a beam group.

As described herein, a CSI reporting may be interchangeably used with and/or refer to CSI measurement, beam reporting, and/or beam measurement.

As described herein, a RS resource set may be used interchangeably with RS ID.

Configurations for CSI and/or Beam Reporting

In certain representative embodiments, one or more of following configurations may be used for CSI and/or beam reporting configurations. A WTRU 102 may be configured with one or more CSI report configurations. The CSI report configurations may include any (e.g., one or more) of the following: (1) a report configuration type (e.g., periodic, semi-persistent on PUCCH, semi-persistent on PUSCH, and/or aperiodic), (2) a report quantity (e.g., CRI-RI-PMI-CQI, CRI-RI-i1, CRI-RI-i1-CQI, CRI-RSRP, SSB-Index-RSRP, CRI-RI-LI-PMI-CQI, CRI-SINR, and/or SSB-Index-SINR), (3) a report frequency configuration, (e.g., CQI format indicator (wideband CQI or subband CQI), PMI format indicator (e.g., wideband PMI or subband PMI), and/or CSI reporting band), (4) a time restriction for channel measurements, (5) a time restriction for interference measurements, (6) a codebook configuration, (7) group based beam reporting, (8) a CQI table, (9) a subband size, (10) a non-PMI port indication, (11) a report slot configuration and/or offset list, (12) a CSI report periodicity and/or offset, (13) PUCCH resources for CSI reporting, and/or (14) a port index.

### Configurations for CSI Measurement

In certain representative embodiments, one or more of following configurations may be used for measurement configuration of CSI and/or beam reporting. A WTRU 102 may be configured with one or more CSI measurement configurations. The CSI measurement configurations may include any (e.g., one or more) of the following: (1) a RS for channel measurement, (2) a RS for interference measurement (e.g., zero power or non-zero power), (3) a report trigger size, (4) an Aperiodic trigger state list, (5) a semi-persistent on PUSCH trigger state list, (6) any associated CSI resource configurations, and/or (7) any associated CSI report configurations.

### Configurations for CSI Resources

In certain representative embodiments, one or more of following configurations may be used for CSI resource configurations. A WTRU 102 may be configured with one or more CSI resource configurations. The CSI resource configurations may include any (e.g., one or more) of the following: (1) a CSI resource configuration ID, (2) a RS resource set for channel measurement, (3) a RS resource set for interference measurement, (4) a bandwidth part ID, and/or (5) a resource type (e.g., aperiodic, semi-persistent or periodic).

### Configurations for CSI Resource Sets

In certain representative embodiments, one or more of following configurations may be used for CSI resource sets. A WTRU 102 may be configured with one or more CSI resource sets. The CSI resource configurations may include any (e.g., one or more) of the following: (1) a RS resource set ID, (2) RS resource(s) for the RS resource set, (3) a repetition (i.e., on or off), (4) an aperiodic triggering offset (e.g., a number of slots such as 0 to 6 slots), and/or (5) TRS information (e.g., true or not).

### Configurations for RS Resources

In certain representative embodiments, one or more of following configurations may be used for RS resources. A WTRU 102 may be configured with one or more RS resources. The RS resource configurations may include any (e.g., one or more) of the following: (1) a RS resource ID, (2) a resource mapping (e.g., REs in a PRB), (3) a power control offset (e.g., a value such as −8 to 15), (4) a power control offset with SS (e.g., −3 dB, 0 dB, 3 dB, 6 Db), (5) a scrambling ID, (6) a periodicity and/or offset, and/or (7) QCL information (e.g., based on a TCI state).

Modes of Operation for Hybrid Operation of Non-Orthogonal RS Measurement and/or Contention Based CSI Reporting

In certain representative embodiments, one or more of modes of operation may be used for (e.g., non-orthogonal) RS measurement and/or contention based CSI reporting. For example, a WTRU 102 may determine a mode of operation (e.g., from among multiple possible modes) based on any of CSI and/or beam reporting configurations, CSI measurement configurations, CSI resources, RS resources, RS resource sets, and/or any information associated with or indicated by the foregoing.

In certain representative embodiments, a mode of operation may be determined based on a number of configured RS resource sets associated with one or more of a CSI report configuration, a CSI measurement configuration, and/or a CSI resource configuration. For example, a WTRU 102 may be configured with one RS resource set associated with one or more of a CSI report configuration, a CSI measurement configuration, and/or a CSI resource configuration, and the WTRU 102 may determine a first mode of operation (e.g., orthogonal RS transmission and/or normal CSI reporting). For example, the WTRU 102 may be configured with two or more RS resource sets associated with one or more of a CSI report configuration, the WTRU 102 may determine a second mode of operation (e.g., non-orthogonal RS measurement and/or contention based CSI reporting).

In certain representative embodiments, a mode of operation may be determined based on a number of configured periodicities and offsets of RS resource sets and/or CSI reporting associated with any of a CSI report configuration, a CSI measurement configuration, a CSI resource configuration, RS resource set, and/or a RS resource. For example, a WTRU 102 may configured with one periodicity and/or offset associated with one or more of a CSI report configuration, a CSI measurement configuration, and/or a CSI resource configuration, and the WTRU 102 may determine a first mode of operation (e.g., orthogonal RS transmission and/or normal CSI reporting). For example, the WTRU 102 may be configured with two or more periodicities and/or offsets associated with one or more of a CSI report configuration, a CSI measurement configuration and/or a CSI resource configuration, and the WTRU 102 may determine a second mode of operation (e.g., non-orthogonal RS measurement and/or contention based CSI reporting).

In certain representative embodiments, a mode of operation may be determined based on a number of configured RS IDs associated with a RS resource. For example, a WTRU 102 may be configured with one RS ID associated with a RS resource, and the WTRU 102 may determine a first mode of operation (e.g., orthogonal RS transmission and/or normal CSI reporting). For example, a WTRU 102 may be configured with two or more RS IDs associated with a RS resource, and the WTRU 102 may determine a second mode of operation (e.g., non-orthogonal RS measurement and/or contention based CSI reporting).

In certain representative embodiments, a mode of operation may be determined based on a number of configured TCI states associated with a RS resource. For example, a WTRU 102 may be configured with one TCI state associated with a RS resource, and the WTRU 102 may determine a first mode of operation (e.g., orthogonal RS transmission and/or normal CSI reporting). For example, a WTRU 102 may be configured with two or more TCI states associated with a RS resource, and the WTRU 102 may determine a second mode of operation (e.g., non-orthogonal RS measurement and/or contention based CSI reporting).

In certain representative embodiments, a mode of operation may be determined based on an association between one or more of CSI report configurations, CSI measurement configurations and/or CSI resource configurations. For example, a WTRU 102 may be configured with a first CSI report configuration which is not associated with any other CSI report configuration, the WTRU 102 may determine a first mode of operation. For example, a WTRU 102 may be configured with a first CSI report configuration associated with a second CSI report configuration (e.g., for non-orthogonal RS measurement and/or contention based CSI reporting), and the WTRU 102 may determine a second mode of operation.

In certain representative embodiments, a mode of operation may be determined based on data traffic (e.g., data rate, packet arrival rate, packet transmission rate, average, minimum and/or maximum values thereof.) For example, a WTRU 102 may be scheduled with packets (e.g., for one or more of DL, UL and SL) with a packet arrival rate which is less than or equal to a threshold, the WTRU 102 may determine a first mode of operation. For example, a WTRU 102 may be scheduled with packets (e.g., for one or more of DL, UL and SL) with a packet arrival rate which is larger than a threshold, the WTRU 102 may determine a second mode of operation.

In certain representative embodiments, a mode of operation may be determined based on a configured report quantity of a CSI report configuration. For example, a WTRU 102 may be configured with a first CSI report configuration (e.g., without a RS resource set indicator, RS ID indicator, and/or a RS resource ID indicator), the WTRU 102 may determine a first mode of operation. For example, a WTRU 102 may be configured with a second CSI report configuration (e.g., with a RS resource set indicator, RS ID indicator, and/or a RS resource ID indicator), the WTRU 102 may determine a second mode of operation.

In certain representative embodiments, a mode of operation may be determined based on a configuration of a contention based CSI reporting resource. For example, a WTRU 102 may not be configured with a first type (e.g., normal or non-contention based) of CSI reporting resource, the WTRU 102 may determine the mode of operation as a first mode of operation. For example, a WTRU 102 may be configured with second type (e.g., contention based) of CSI reporting resource, the WTRU 102 may determine the mode of operation as a second mode of operation.

In certain representative embodiments, a mode of operation may be determined based on a WTRU capability and a configuration received from a base station (e.g., gNB) based on the WTRU capability reporting.

In certain representative embodiments, a WTRU 102 may request and/or indicate a preferred mode of operation for CSI measurement and reporting. For example, a WTRU 102 may be capable of supporting multiple modes of operation (e.g., normal CSI measurement/reporting and non-orthogonal RS measurement/contention based CSI reporting) and measurements at a WTRU 102. The WTRU 102 may indicate a preferred mode of operation to the base station (e.g., gNB). For example, on condition that measured traffic from other WTRUs 102 and/or base stations is larger than a threshold, a WTRU 102 may indicate a preference for a first mode of operation (e.g., normal CSI measurement and reporting) as a preferred mode of operation. On condition that the measured traffic is less than or equal to the threshold, the WTRU 102 may indicate a preference for a second mode of operation (e.g., non-orthogonal RS measurement and/or contention based CSI reporting).

In certain representative embodiments, a threshold may be based on any of a predefined value, a preconfigured and/or indicated value by gNB (e.g., based on one or more of RRC, MAC CE and DCI), and/or a determined value by a WTRU 102.

### Non-Orthogonal RS Measurement

### Sharing RS Resource Sets for Multiple Beam Groups

Association Between Two or More RS Sets and any of a CSI Report Configuration, CSI Measurement Configuration, and/or CSI Resource Configuration

In certain representative embodiments, a WTRU 102 may be configured with two or more RS resource sets and/or two or more RS IDs for CSI/beam measurement. The two or more RS resource sets (or RS IDs) may be configured and/or associated with any of CSI report configuration(s), CSI measurement configuration(s), and/or CSI resource configuration(s). As shown in FIG. 3, multiple beam groups may be associated with multiple CSI-RS resource sets. In other examples, multiple beam groups may be associated with multiple RS resource sets.

For example, two or more RS resource sets and/or two or more RS IDs (e.g., for channel measurement and/or interference measurement) may be associated with a CSI report configuration (e.g., by configuring two or more RS resource set IDs and/or RS IDs) at a WTRU 102 (e.g., by a base station). Each of the two or more RS resource sets may be associated with two or more CSI report configurations. For example, a first RS resource set may be associated with a first CSI report configuration (e.g., more frequent and/or periodic/semi-persistent reporting). For example, a second RS resource set may be associated with a second CSI report configuration (e.g., less frequent and/or semi-persistent/aperiodic reporting).

For example, two or more RS resource sets and/or two or more RS IDs (e.g., for channel measurement and/or interference measurement) may be associated with a CSI measurement configuration (e.g., by configuring two or more RS resource set IDs and/or RS IDs). Each of the two or more RS resource sets may be associated with two or more CSI measurement configuration. For example, a first RS resource set may be associated with a first CSI measurement configuration. A second RS resource set may be associated with a second CSI measurement configuration.

For example, two or more RS resource sets and/or two or more RS IDs (e.g., for channel measurement and/or interference measurement) may be associated with a CSI resource configuration (e.g., by configuring two or more RS resource set IDs and/or RS IDs). Each of the two or more RS resource sets may be associated with two or more CSI resource configurations. For example, a first RS resource set may be associated with a first CSI resource configuration and a second RS resource set may be associated with a second CSI resource configuration.

In certain representative embodiments, the association of the two or more RS resource sets and/or RS IDs may be configured by RRC, indicated by MAC CE and/or DCI from a base station (e.g., gNB).

In certain representative embodiments, a WTRU 102 may determine one or more of RS resource sets of the two or more RS resource sets and/or one or more RS IDs of the two or more RS IDs based on a configuration (e.g., any of CSI report configuration(s), CSI measurement configuration(s), and/or CSI resource configuration(s)).

For example, a WTRU 102 may be configured with a first RS resource set and a second RS resource set. The WTRU 102 may measure the first RS resource set (e.g., more frequent measurement) for a first CSI reporting (e.g., more frequent reporting). Based on the measurement, the WTRU 102 may report the first CSI reporting in a first CSI reporting resource. The WTRU 102 may measure both the first RS resource and the second RS resource (e.g., less frequent measurement) for a second CSI reporting (e.g., less frequent reporting). Based on the measurement, the WTRU 102 may report the second CSI reporting in a second CSI reporting resource. The configuration of the second RS resource set may be based on the first RS resource set. For example, a periodicity and/or an offset of the second RS resource set may be a multiple of periodicity and offset of the first RS resource set.

For example, any (e.g., each) RS resource of the first RS resource set may be associated with any (e.g., each) RS resource of the second RS resource set. The WTRU 102 may determine a configuration of RS resources of any (e.g., each) second RS resource set based on the association. For example, a periodicity and/or offset of a RS resource in a second RS resource set may be a multiple of a periodicity and/or offset of an associated RS in the first RS resource. For example, a resource mapping of any RS resources in the second RS resource set may be based on (e.g., identical with) a resource mapping of any associated RSs in the first RS resource. For example, a power control offset of any RS resource in the second RS resource set may be based on (e.g., identical with) a power control offset of any associated RS in the first RS resource. For example, power control offset of a RS resource in the second RS resource set may be based on a configured difference based on power control offset of an associated RS in the first RS resource. For example, QCL information of a RS resource (e.g., except QCL Type-D) in the second RS resource set may be based on (e.g., identical with) QCL information of an associated RS in the first RS resource except QCL Type-D.

For example, the first CSI reporting may be based on a normal CSI reporting method (e.g., periodic, semi-static and aperiodic CSI reporting) and the second CSI reporting may be based on a different CSI reporting method, such as contention-based CSI reporting.

For example, a transmission type of a first RS resource set and a second RS resource set may be different. As an example, the transmission type of the first RS resource set may be periodic or semi-persistent, and transmission type of the second RS resource set may be different (e.g., semi-persistent or aperiodic).

In certain representative embodiments, the second RS resource set and/or the second CSI reporting may be activated and/or triggered based on one or more criteria being satisfied. For example, a trigger may be a quality (e.g., CQI, (L1-)SINR, (L1-)RSRP) based on measurement of one or more resources of the first RS resource set being greater than or equal to a threshold.

In some embodiments, the second RS resource set may be activated/triggered on condition that at least one quality of the first RS resource set is less than or equal to a threshold. For example, when a WTRU 102 reports CSI with a quality which is less than or equal to the threshold, the WTRU 102 may receive the second RS resource set based on the configuration (e.g., in a latest resource after the WTRU reporting time plus a processing time associated with the second RS resource set configuration). For example, the second CSI reporting may be activated/triggered on condition that the quality of the first RS resource set is less than or equal to a threshold. In an example, when the WTRU 102 reports CSI with a quality which is less than or equal to the threshold, the WTRU 102 may report the second CSI reporting based on the configuration (e.g., using contention-based CSI reporting).

In some embodiments, a quality of the second RS resource set may be (e.g., determined to be) greater than or equal to a quality of the first RS resource set. For example, the second CSI reporting may be activated/triggered on condition that the quality of the first RS resource set is less than the quality of the second RS resource set. For example, when the WTRU 102 reports CSI with a quality which is less than or equal to the threshold, the WTRU 102 may report the second CSI reporting based on the configuration.

In certain representative embodiments, a WTRU 102 may determine one or more qualities of a RS resource set using one or more of maximum, minimum and/or average value of the qualities of one or more resources in the RS resource set. For example, a determination method for the quality (e.g., maximum, minimum, and/or average) of any resource may be configured by a base station (e.g., gNB via RRC and/or MAC CE).

In some embodiments, the second RS resource set may be activated/triggered on condition that a new best beam and/or beam group is determined. For example, the second RS resource set may be activated/triggered on condition that the WTRU 102 finds one or more best new beams and/or beam groups. When the WTRU 102 reports CSI with the one or more best new beams and/or beam groups (e.g., which may be different with previously reported best beams and/or beam groups), the WTRU 102 may receive the second RS resource set based on the configuration (e.g., in a latest resource after WTRU reporting time plus a processing time associated with the second RS resource set configuration). For example, the second CSI reporting may be activated/triggered on condition that the WTRU 102 finds one or more best new beams and/or beam groups. When the WTRU 102 identifies CSI with the one or more best new beams and/or beam groups (e.g., which may be different with previously reported best beams and/or beam groups), the WTRU 102 may report the second CSI reporting based on the configuration (e.g., based on contention based CSI reporting).

In some embodiments, a WTRU 102 may determine that a difference between a reported quality and a newly measured quality is greater than or equal to a threshold. For example, the second RS resource set may be activated/triggered on condition that a reported quality of the first RS resource set minus a newly measured quality of the first RS resource set is greater than a threshold. For example, when the WTRU 102 reports CSI with a quality with is X dB (e.g., a threshold value) lower than the previously reported quality, the WTRU 102 may receive the second RS resource set based on the configuration (e.g., in a latest resource after WTRU reporting time plus a processing time associated with the second RS resource set configuration). For example, the second CSI reporting may be activated/triggered on condition that a reported quality of the first RS resource set minus a (e.g., newly) measured quality of the first RS resource set is greater than or equal to a threshold. For example, when the WTRU 102 identifies CSI with a quality with is X dB (e.g., a threshold value) lower than the previously reported quality, the WTRU 102 may report the second CSI reporting based on the configuration (e.g., using contention-based CSI reporting).

In some embodiments, a WTRU 102 may determine that a difference between a reported best beam and/or beam group and a new best beam and/or beam group is greater than or equal to a threshold. For example, the second RS resource set may be activated/triggered on condition that a WTRU 102 reports a new best beam (e.g., via CRI). For example, when the WTRU 102 reports a new CRI which is different than a previously reported CRI, the WTRU 102 may receive the second RS resource set based on the configuration (e.g., in a latest resource after WTRU reporting+processing time according to the second RS resource set configuration). For example, the second CSI reporting may be activated/triggered on condition that a WTRU 102 reports a new best beam (e.g., via CRI). In an example, when the WTRU 102 identifies CSI with a new CRI (e.g., which is different than a previously reported CRI), the WTRU 102 may report the second CSI reporting based on the configuration (e.g., using contention-based CSI reporting).

In some embodiments, a WTRU 102 may determine that an UL transmission power associated with (e.g., recent) transmissions (e.g., any of PUSCH, PUCCH, PRACH and/or SRS) is greater than or equal to a threshold. For example, the second RS resource set may be activated/triggered on condition that a UL transmission power associated with one or more (e.g., latest) transmissions is greater than or equal to a threshold. For example, the second CSI reporting may be activated/triggered on condition that a UL transmission power associated with one or more (e.g., latest) transmissions is greater than or equal to a threshold.

In some embodiments, a WTRU 102 may determine that a measured and/or reported interference is greater than a threshold. For example, the second RS resource set may be activated/triggered on condition that a measured interference is greater than a threshold. For example, on condition that a measured interference based on a measurement of an interference measurement resource associated with the first RS resource set is greater than a threshold, the WTRU 102 may activate the second RS resource set. For example, a second RS CSI reporting may be activated/triggered on condition that a measured interference is greater than or equal to a threshold. For example, where a measured interference based on measurement of an interference measurement resource associated with the first RS resource set is greater than a threshold, the WTRU 102 may activate the second CSI reporting.

In some embodiments, a WTRU 102 may determine that (e.g., an amount of) scheduled traffic is less than or equal to a threshold. For example, the second RS resource set may be activated/triggered on condition that scheduled traffic (e.g., associated with any resource sets and/or channels) satisfies a condition (e.g., threshold).

In some embodiments, a WTRU 102 may determine that a data arrival rate is greater than or equal to a threshold. For example, the second RS resource set may be activated/triggered on condition that a data arrival rate (e.g., associated with any resource sets and/or channels) does not satisfy a threshold.

In some embodiments, a WTRU 102 may determine that a number of LBT failures is greater than or equal to a threshold. For example, the second RS resource set may be activated/triggered on condition that the number of LBT failures (e.g., associated with any resource sets and/or channels) satisfies a condition (e.g., threshold).

In some embodiments, a WTRU 102 may determine that a priority of scheduled traffic is greater than or equal to a threshold. For example, the second RS resource set may be activated/triggered on condition that scheduled traffic (e.g., associated with one or more channels, such as PUSCH, PDSCH, and/or PSSCH) does not satisfy a threshold.

In certain representative embodiments, a first CSI reporting and/or a second CSI reporting may be based on any of the following: (1) contention-based CSI reporting, (2) a RS resource set indicator, (3) a RS ID indicator, (4) a combination of information associated with a RS resource set indicator and a RS resource set, (5) a general RS resource index that is applicable and/or associated with any (e.g., all) configurations, (6) a CSI measurement reset (e.g., for a previously measured CSI-RS resource set with a previous CSI-RS ID), and/or (7) any CSI parameters.

For example, a WTRU 102 may indicate one or more preferred RS resource sets to a gNB based on one or more measurements. The WTRU 102 may indicate one or more explicit RS resource set IDs to indicate the preferred RS resource sets. The WTRU 102 may toggle one or more indicator bits to indicate a new CSI report is based on a different RS resource set from a previous CSI report.

For example, a WTRU 102 may indicate one of RS ID in an indicated CSI-RS resource set to a base station (e.g., gNB). The WTRU 102 may use an explicit ID or toggle for the indication.

For example, a WTRU 102 may jointly indicate one or more preferred RS resource sets and one or more preferred RS resource IDs for any (e.g., each) RS resource set of the one or more preferred RS resource sets.

For example, a WTRU 102 may report one or more generalized RS resource indices that may count across all configurations (e.g., one or more of a CSI report configuration, a CSI measurement configuration, and/or a CSI resource configuration). The reported one or more generalized RS resource indices may indicate preferred RS resource sets based on association with another RS resource set.

For example, a WTRU 102 may report one or more CSI parameters such as CRI, SSBRI, RI, LI, PMI, CQI, L1-RSRP, and/or L1-SINR with (e.g., in addition to) the RS resource set indicator and/or RS ID indicator. Any (e.g., each) CSI parameter may be based on measurement of or associated with the reported RS resource set and/or RS ID.

### Base Station Confirmation for WTRU-Centric RS Changes

In certain representative embodiments, a WTRU 102 may modify CSI measurement and reporting behavior on at least one set of CSI-RS resources upon receiving an implicit or explicit indication (e.g., from the physical layer or MAC signaling). A change of CSI measurement and reporting behavior (e.g., mode) may be referred to herein as a “CSI change.” In certain representative embodiments, a CSI change may include activation and triggering of RS resource sets and/or reporting as described in above. For example, a CSI change may include any of the following: (1) initiating CSI measurement on a first set of RS resources, (2) stopping CSI measurement on a second set of RS resources, (3) modifying a set of occasions (e.g. periodicity and/or offset) for a set of RS resources, (4) initiating (or activating) CSI reporting for a first CSI reporting configuration, (5) stopping (or deactivating) CSI reporting for a second CSI reporting configuration, (6) modifying a set of occasions (e.g., periodicity and/or offset) for reporting CSI for a CSI reporting configuration, (7) modifying a state associated to a set of RS resources (e.g., from a “Monitoring” state to an “Active” state), and/or (8) modifying a state associated to a CSI reporting configuration (e.g., from a “Monitoring” state to an “Active” state).

### Implicit Indication Based on Indicated TCI State

In certain representative embodiments, a WTRU 102 may apply a CSI change upon reception of information indicating a TCI state which is applicable to a channel. For example, a PDCCH indicating a certain TCI state applicable to any of PDCCH, PDSCH, PUSCH and/or PUCCH. For example, the configuration of a TCI state may include an identity (e.g., ID) of an associated RS resource set and/or CSI-RS reporting configuration. Upon reception of MAC and/or DCI signaling indicating a TCI state, the WTRU 102 may change the state of the associated RS resource set to an Active state and change the state of other RS resource sets to an Inactive and/or Monitoring state.

In certain representative embodiments, the configuration of a TCI state may include a group identity parameter. For example, any (e.g., each) RS resource set and/or CSI-RS reporting configuration may include a group identity parameter. A group identity parameter may be indicated (e.g., implicitly or explicitly) from a RRC configuration. For example, a first and second set of TCI states may correspond to a first and second group, respectively, and a first and second set of CSI resource sets may correspond to the first and second group, respectively. For example, upon reception of MAC and/or DCI signaling indicating a TCI state, the WTRU 102 may change the state of any (e.g., all) RS resource sets and/or CSI-RS reporting configurations with a corresponding group identity parameter to an Active state, and/or may change the state of other RS resource sets and/or CSI-RS reporting configurations to an Inactive or Monitoring state.

### Implicit Indication Based on Coresets and Search Spaces

In certain representative embodiments, a WTRU 102 may apply a CSI change upon reception of a transmission (e.g., PDCCH transmission) from a (e.g., specific) Coreset and/or search space. For example, the configuration of a Coreset may include an identity of an associated RS resource set and/or may include a group identity parameter as previously described for a TCI state. As another example, a CSI resource set and/or a CSI reporting configuration may include an identity of a Coreset.

### Explicit Indication or Confirmation

In certain representative embodiments, a WTRU 102 may apply a CSI change according to an explicit indication, such as an indication contained in a MAC CE and/or DCI. For example, the indication may include or be associated with a set of RS resource sets and/or CSI reporting configurations and respective states. The indication may include (e.g., only) the set of RS resource sets and/or CSI reporting configurations for which the state should be set to an Active state (e.g., remaining sets may be changed to an Inactive or Monitoring state).

In certain representative embodiments, a WTRU 102 may apply a CSI change according to information that the WTRU 102 includes in a report and a confirmation (e.g., received by DCI and/or MAC CE). A WTRU 102 may first report CSI information for first and second RS resource sets. For example, the CSI information may include any of: (1) an indication of a (e.g., best) RS resource set, (2) an indication of a RS (e.g., CSI-RS or SSB, via CRI) for each RS resource set, or across RS resource sets, and/or (3) at least one corresponding measurement (e.g., CSI-RSRP or CSI-SINR). After, the WTRU 102 may then receive a confirmation (e.g., via DCI and/or MAC CE) confirming a CSI change based on the reported information. For example, a WTRU 102 may report a best RS that is part of a first RS resource set, and may subsequently receive a DCI and/or MAC CE with confirmation. The WTRU 102 may change the state of the first RS resource set to an Active state, and/or change the state of other RS resource sets to an Inactive or Monitoring state. The WTRU 102 may apply changes corresponding to a WTRU report and/or request transmitted in a slot ‘n’ where the WTRU 102 has received a confirmation between a slot ‘n+K1’ and a slot ‘n+K2’. For example, ‘K1’ may be pre-defined and/or ‘K2’ may depend on a periodicity for a CSI reporting configuration.

### QCL Type-D Determination Based on Non-Orthogonal RS Measurement

As described herein, the terms RS resource, channel, and/or signal may be used interchangeably.

As described herein, the terms source reference signal, TCI state, QCL type-D, Rx beam index, Tx beam index, Rx spatial filter, and/or beam may be used interchangeably.

In certain representative embodiments, a RS resource may be configured with a TCI state (e.g., TCI-StateId). For example, a TCI state may indicate an associated source RS (e.g., SSB, TRS, and/or periodic CSI-RS) to determine one or more QCL parameters for the reception and/or measurement of the RS resource. A WTRU 102 may use the determined one or more QCL parameters from the source reference signal to receive and/or measure an RS resource. For example, a TCI state may be associated with a reference signal (e.g., SSB, CSI-RS, etc.). For example, the QCL parameters may include any of Doppler shift, Doppler spread, average delay, delay spread, and/or a spatial Rx parameter. For example, a source reference signal may be at least one of a SSB, TRS, CSI-RS, SRS, PRS, and/or DM-RS.

In certain representative embodiments, a RS resource may be configured and/or associated with one or more TCI states. A single TCI state, within the configured and/or associated TCI states, may be determined for the reception and/or measurement of the RS resource at a given time. For example, a WTRU 102 may be configured to measure a RS resource and the RS resource may be configured and/or associated with one or more TCI states. The WTRU 102 may determine a TCI state within the configured and/or associated TCI states to measure the RS resource based on one or more criteria and/or parameters.

For example, a WTRU 102 may determine a TCI state within the configured and/or associated TCI states using an associated (e.g., PDCCH) search space and/or CORESET on condition measurement of the RS resource is triggered. For example, a WTRU 102 may receive a DCI which may trigger measurement of a RS resource. On condition that the RS resource is associated with more than one TCI state, the WTRU 102 may determine which TCI state to use for the RS resource measurement based on the associated PDCCH search space and/or the CORESET.

For example, a WTRU 102 may determine a TCI state within the configured and/or associated TCI states using an associated coresetPoolIndex. For example, one or more CORESETs may be used and each CORESET may be associated with a coresetPoolIndex. When a WTRU 102 receives a DCI triggering RS resource measurement, the DCI may be received in a PDCCH search space (e.g., having a corresponding CORESET). An associated coresetPoolIndex for a DCI may be referred to as the coresetPoolIndex used, configured, or determined for the corresponding CORESET.

Each TCI state may be associated with a coresetPoolIndex. On condition that a WTRU 102 receives a DCI in a (e.g., PDCCH) search space associated with a CORESET with a first coresetPoolIndex, the WTRU 102 may determine a first TCI state in the associated TCI states for the measurement of the RS resource. On condition that a WTRU 102 receives a DCI in a (e.g., PDCCH) search space associated with a CORESET with a second coresetPoolIndex, the WTRU 102 may determine a second TCI state in the associated TCI states for the measurement of the RS resource.

For example, a WTRU 102 may determine a TCI state within the configured and/or associated TCI states using an associated RS resource set index. For example, one or more RS resource sets may be used and any (e.g., each) RS resource set may be associated with any (e.g., each) TCI state of the configured TCI states. The WTRU 102 may determine a TCI state associated with a RS resource set index in a WTRU report (e.g., CSI reporting). For example, the associated RS resource set may be determined based on a reported (e.g., generalized) RS resource index that counts across all associated configurations from the WTRU 102. For example, the associated RS resource set may be determined based on joint information of a RS resource set indicator and a RS resource set from the WTRU 102. For example, the associated RS resource set may be determined based on an indication (e.g., from a base station). For example, a gNB may indicate (e.g., based on one or more of RRC, MAC CE and/or DCI) a RS resource set index and the WTRU 102 may determine a TCI state, of the configured TCI states, associated with the RS resource set index.

For example, a WTRU 102 may determine a TCI state within the configured and/or associated TCI states using an associated RS ID. For example, one or more RS IDs may be used and each RS ID may be associated with any (e.g., each) TCI state of configured TCI states. The WTRU 102 may determine a TCI state associated with an RS ID in a WTRU report (e.g., CSI reporting). An associated RS ID may be determined based on an indication (e.g., from a base station). For example, a gNB may indicate (e.g., based on one or more of RRC, MAC CE and/or DCI) a RS ID and the WTRU 102 may determine a TCI state, of the configured TCI states, associated with the RS ID.

For example, a WTRU 102 may determine a TCI state within the configured and/or associated TCI states using an associated RS resource ID. For example, one or more RS resource IDs may be used and any (e.g., each) RS resource ID may be associated with any (e.g., each) TCI state of configured TCI states. The WTRU 102 may report its preferred RS resource ID and/or a RS resource ID for the operation may be indicated (e.g., by a base station).

For example, a WTRU 102 may determine a TCI state within the configured and/or associated TCI states using an identity of a (e.g., PDCCH) search space and/or CORESET. Any (e.g., each) TCI state may be associated with an identity of a (e.g., associated) search space and/or CORESET. A WTRU 102 may determine a TCI state within the associated TCI states based on the search space identity and/or CORESET identity in which a WTRU 102 may receive a DCI, such as a DCI triggering the RS resource measurement.

For example, a WTRU 102 may determine a TCI state within the configured and/or associated TCI states using time and/or location information, such as where the WTRU 102 may receive or measure the RS resource. For example, a WTRU 102 may receive/measure the RS resource in a first time location (e.g., slot, symbol, radio frame, subframe, or transmission time interval (TTI)), and the WTRU 102 may determine a first TCI state within the associated TCI states. The WTRU 102 may receive/measure the RS resource in a second time location, and the WTRU 102 may determine a second (e.g., different) TCI state within the associated TCI states. The first and the second time locations may be determined as a function of a time index (e.g., slot index, radio frame number, SFN).

For example, a WTRU 102 may determine a TCI state within the configured and/or associated TCI states using a physical cell-id (PCID). The physical-cell-id may be determined or used for a PDCCH and/or a PDSCH reception in a time location (e.g., slot), such as where the WTRU 102 may receive or measure the RS resource. As described herein, a physical cell-id (PCID) may be used interchangeably with TRP-id, virtual cell ID, CoresetPoolIndex, beam index, beam group index, BWP-id, and/or carrier id.

In certain representative embodiments, a WTRU 102 may be configured with one or more time windows. A WTRU 102 may perform a measurement of a RS resource with all TCI states configured in a first time window. The WTRU 102 may use the measurement in the first time window to determine a TCI state to use for perform a measurement of the RS resource in a second time window. In some embodiments, the TCI state may be determined using any of a time index, a TCI state, and/or expiration of a configured and/or predetermined time window (e.g., period). For example, in the first time window, a TCI state for the RS resource may be determined based on a time index (e.g., symbol number, slot number, subframe number, radio frame number, and/or SFN). The WTRU 102 may report the determined TCI state in the first time window. For example, in the second time window, a TCI state for the RS resource may be based on the TCI state determined in the associated first time window. The WTRU 102 may report CSI reporting quantities (e.g., PMI, RI, CQI, CRI, etc.) based on the measurement of the RS resource, and the WTRU 102 may also report the determined TCI state which is used for the RS resource measurement in the second time window. As described herein, time window may be interchangeably used with timer, counter, and/or time duration or interval.

In certain representative embodiments, a scrambling ID of a RS resource may be determined based on a (e.g., determined) TCI state. For example, a RS resource may be associated with one or more TCI states (e.g., by configuration) and one of the associated TCI states may be determined for a WTRU 102 to receive/measure the RS resource in certain time and/or frequency resources. The scrambling ID of the RS resource in time and/or frequency resource locations may be determined based on the TCI state. As described herein, the terms scrambling ID, sequence ID, sequence initialization ID, C_init, and/or scrambling sequence may be used interchangeably.

In certain representative embodiments, a WTRU 102 may be configured with a RS resource without QCL Type-D information (and/or a TCI state). The WTRU 102 may determine a QCL Type-D (and/or a TCI state) for the RS resource, such as when performing measurement based on one or more other uses of QCL information elsewhere by the WTRU. For example, a QCL Type-D used for measuring and/or receiving a RS resource may be determined using a QCL Type-D of a channel (e.g., for a PDSCH or a PDCCH) in a slot. A WTRU 102 may measure a RS resource in a slot and a QCL Type-D for the RS resource may be determined as the QCL Type-D used for a channel transmission (e.g., a PDCCH and/or a PDSCH) in the same slot as the RS resource. For example, a QCL Type-D used for measuring and/or receiving a RS resource may be determined using a latest QCL Type-D determined in an earlier slot. For example, a QCL Type-D may be determined or indicated for the RS resource dynamically over time (e.g., via DCI). Once the QCL Type-D is determined or indicated, it may be used until the WTRU 102 is configured or indicated with a new QCL Type-D. For example, a QCL Type-D used for measuring and/or receiving a RS resource may be determined using a QCL Type-D determined and/or associated with a search space in which a WTRU 102 may receive a DCI (e.g., triggering measurement of the RS resource). A WTRU 102 may be triggered to measure a RS resource in an associated DCI and the DCI may be monitored in a search space. The QCL Type-D used for monitoring for the DCI may be used or determined for the RS resource.

In certain representative embodiments, a WTRU 102 may be configured with a RS resource with one or more TCI states (and/or QCL Type-Ds). A first TCI state may be a (e.g., default) TCI state which may be used when no other (e.g., specific) TCI state is determined. For example, a TCI state may be determined for a RS resource based on the TCI state used for another transmission (e.g., PDCCH and/or PDSCH) which may be received or monitored in the same slot in which the WTRU 102 may also measure the RS resource. If there is no (e.g., PDCCH and/or PDSCH) reception in a slot in which the WTRU 102 may receive or measure the RS resource, the WTRU 102 may determine to use the default TCI state for the RS resource.

### Contention-Based CSI Reporting

In certain representative embodiments, a WTRU 102 may be configured and/or indicated with one or more common reporting resources for multiple WTRUs 102 for CSI reporting (e.g., based on one or more of RRC, MAC CE and/or DCI). Based on the configuration, a WTRU 102 may transmit a CSI report in the one or more common reporting resources for multiple WTRUs 102 by transmitting one or more channels and/or signals (e.g., to a gNB). The WTRU 102 may transmit a CSI report when one or more of predefined or configured conditions are satisfied. One or more of following conditions may be used to activate and/or trigger the transmission of the CSI report.

For example, a quality (e.g., CQI, (L1-)SINR, and/or (L1-)RSRP) based on measurement of one or more resources of a RS resource set being less than or equal to a threshold may be used (e.g., to cause a CSI report to be transmitted).

For example, a quality (e.g., CQI, (L1-)SINR, and/or (L1-)RSRP) to be reported being less than or equal to a threshold may be used (e.g., to cause a CSI report to be transmitted).

For example, to determine one or more qualities of a RS resource set, one or more of a maximum, minimum and/or average values of the qualities of one or more resources in the RS resource set may be used. A determination method for the quality (e.g., maximum, minimum, and/or average) may be configured (e.g., by a gNB via RRC and/or MAC CE).

For example, a relation between a reported quality and a newly measured quality relative to a threshold may be used (e.g., to cause a CSI report to be transmitted). As an example, contention-based CSI reporting may be activated and/or triggered on condition that a difference between (1) an earlier reported quality (e.g., in the previous reporting instance) of a RS resource set and/or resource and (2) a newly measured quality of the first RS resource set is greater than or equal to a threshold. For example, when a WTRU 102 reports CSI with a quality with is X dB (e.g., threshold) lower than the previously reported quality, the WTRU 102 may report and/or use contention-based CSI reporting.

For example, a determination of a new best beam and/or beam group may be used (e.g., to cause a CSI report to be transmitted). For example, CSI reporting may be activated/triggered on condition that a WTRU 102 reports a new best beam (e.g., via CRI). In an example, when the WTRU 102 reports CSI with a new CRI which is different with a previously reported CRI, the WTRU 102 may report and/or use contention-based CSI reporting.

For example, a relation between a new best beam and/or beam group and a reported best beam and/or beam group relative to a threshold may be used (e.g., to cause a CSI report to be transmitted). For example, the CSI reporting may be activated and/or triggered on condition that a WTRU 102 reports a new best beam (e.g., via CRI) and a quality difference with a previously reported CRI is greater than or equal to a threshold.

Further examples which may be used (e.g., to cause a CSI report to be transmitted) include any of: (1) a transmission power (e.g., in the UL) associated with recent transmissions (e.g., any of PUSCH, PUCCH, PRACH and/or SRS) being greater than or equal to a threshold, (2) a measured interference being greater than or equal to a threshold, (3) scheduled traffic being greater than or equal to a threshold, (4) a data arrival rate being greater than or equal to a threshold, (5) a number of HARQ NACKs (e.g., bits or symbols) being greater than or equal to a threshold, (6) a number of LBT failures being greater than or equal to a threshold, and/or (7) a priority of recently scheduled transmissions (e.g., any of PUSCHs, PDSCHs, and/or PSSCHs) being greater than or equal to a threshold.

### Dynamic Reporting Mode Indication

In certain representative embodiments, a reporting mode (e.g., contention-based, WTRU-triggered, and/or regular/non-contention-based CSI reporting) may be dynamically changed at a WTRU 102. For example, a base station (e.g., gNB) may indicate a mode for regular CSI (e.g., periodic and/or aperiodic) or WTRU trigger-based CSI (e.g., WTRU-specific, group specific and/or cell specific signal). As an example, for general use cases, a gNB may activate a first mode (e.g., for trigger based CSI for efficient operation) at a WTRU 102. For high traffic cases (e.g., concerts, stadiums, etc.), a gNB can activate a second mode (e.g., for regular CSI). For example, a WTRU 102 may recommend its preferred CSI mode via its CSI reporting, such as by using a reporting mode indicator (RMI) (e.g., in regular CSI reporting).

In certain representative embodiments, a WTRU 102 may be configured and/or indicated with one or more reporting modes (e.g., for CSI reporting). For example, a WTRU 102 may be configured and/or indicated (e.g., by a base station) with one of a CSI reporting mode (e.g., contention-based CSI reporting or normal CSI reporting) and/or a transmission type (e.g., periodic, semi-persistent, aperiodic or contention-based CSI). The configuration and/or indication of the CSI reporting mode and/or the transmission type may be per any of a CSI report configuration, a CSI measurement configuration, a CSI resource configuration, a RS resource set, a RS resource, a cell, a TRP, a panel and/or a WTRU.

For example, the configuration and/or indication may be made using any of RRC, MAC CE and/or DCI. For example, the configuration and/or indication may be RRC configured. In another example, the configuration and/or indication may be RRC configured and activated by MAC CE. In another example, the configuration and/or indication may be RRC configured, activated by MAC CE and indicated by DCI. The configuration and/or indication may include any of the following: (1) a CSI reporting mode, (2) a transmission type, (3) a CSI report configuration ID, (4), a CSI resource configuration ID, (5) a CSI measurement configuration ID, (6) a TRP ID, (7) a panel ID, (8) a RS resource set ID, (9) a resource ID, and/or (10) a WTRU ID.

For example, the WTRU 102 may receive the configuration and/or indication indicating one of normal CSI or contention-based CSI as a CSI reporting mode. The indication may be based on explicitly indicating a CSI reporting mode (e.g., 0 for normal CSI and 1 for contention based CSI). The indication may be based on toggling (e.g., if the indication bit is changed from the previous indication, then a new CSI reporting mode may be used, otherwise if the indication bit is same with the previous indication, then a previous CSI reporting mode may be used).

For example, the WTRU 102 may receive the configuration and/or indication indicating one of periodic, semi-persistent, aperiodic or contention-based CSI as a transmission type for an associated CSI reporting.

For example, the WTRU 102 may receive the configuration and/or indication indicating one or more CSI report configuration IDs associated with the indicated CSI reporting mode and/or the indicated transmission type.

For example, the WTRU 102 may receive the configuration and/or indication indicating one or more CSI resource configuration IDs associated with the indicated CSI reporting mode and/or the indicated transmission type.

For example, the WTRU 102 may receive the configuration and/or indication indicating one or more CSI measurement configuration IDs associated with the indicated CSI reporting mode and/or the indicated transmission type.

For example, the WTRU 102 may receive the configuration and/or indication indicating one or more TRP IDs associated with the indicated CSI reporting mode or the indicated transmission type.

For example, the WTRU 102 may receive the configuration and/or indication indicating one or more panel IDs associated with the indicated CSI reporting mode or the indicated transmission type.

For example, the WTRU 102 may receive the configuration and/or indication indicating one or more RS resource set IDs associated with the indicated CSI reporting mode and/or the indicated transmission type.

For example, the WTRU 102 may receive the configuration and/or indication indicating one or more RS resource IDs associated with the indicated CSI reporting mode or the indicated transmission type.

For example, the WTRU 102 may receive the configuration and/or indication indicating one or more WTRU IDs associated with the indicated CSI reporting mode or the indicated transmission type. The indication may be included in a group DCI to indicate CSI reporting mode or transmission type to indicate the WTRU 102 to use the indicated CSI reporting mode and/or the indicated transmission type.

In certain representative embodiments, a WTRU 102 may determine a CSI reporting mode and/or transmission type upon determining that a first set of conditions are satisfied. For example, where the first set of conditions are not satisfied, the WTRU 102 may activate a first CSI reporting mode (e.g., normal CSI reporting) and/or a first transmission type (e.g., periodic, semi-persistent or aperiodic). Where the first set of conditions are satisfied, the WTRU 102 may activate a second CSI reporting mode (e.g., contention-based CSI reporting) and/or a second transmission type (e.g., contention-based CSI reporting). Based on the activation of the second CSI reporting mode, the WTRU 102 may monitor one or more RS resource sets and report contention-based CSI reporting where a second set of conditions are satisfied.

In some representative embodiments, the first set of conditions may include threshold comparisons of any of the following parameters. For example, a condition may be that a quality (e.g., CQI, (L1-)SINR, and/or (L1-)RSRP) based on measurement of one or more resources (e.g., in one or more latest slots) is greater than or equal to a threshold. For example, a condition may be that a quality (e.g., CQI, (L1-)SINR, and/or (L1-)RSRP) to be reported in a CSI reporting is greater than or equal to a threshold. For example, a condition may be that a relation (e.g., difference) between a reported quality and a newly measured quality for one or more measurements and/or CSI reporting instances is less than or equal to a threshold. For example, a condition may be that a relation (e.g., difference) between a quality of a new best beam/beam group and a quality of a reported best beam/beam group is greater than a threshold. As an example, the CSI reporting mode may be activated where a WTRU 102 reports a new best beam (e.g., via CRI) and the quality difference with the previously reported beam (e.g., CRI) is smaller than a threshold for one or more measurements and/or CSI reporting instances. For example, a condition may be that a transmission power associated with one or more recent transmissions (e.g., UL power of any of PUSCH, PUCCH, PRACH and/or SRS) is less than a threshold. For example, a condition may be that a measured interference is less than or equal to a threshold. For example, a condition may be that scheduled traffic is less than or equal to a threshold. For example, a condition may be that a data arrival rate is less than or equal to a threshold. For example, a condition may be that a number of LBT failures is less than or equal to a threshold. For example, a condition may be that a priority of (e.g., recently) scheduled transmissions, such as PUSCHs, PDSCHs, and/or PSSCHs, is less than a threshold.

In some representative embodiments, the second set of conditions may include threshold comparisons of any of the following parameters. For example, a condition may be that a quality (e.g., CQI, (L1-)SINR, and/or (L1-)RSRP) based on measurement of one or more resources (e.g., in one or more latest slots) is less than or equal to a threshold. For example, a condition may be that a quality (e.g., CQI, (L1-)SINR, and/or (L1-)RSRP) to be reported in a CSI reporting is greater than or equal to a threshold. For example, a condition may be that a relation (e.g., difference) between a reported quality and a newly measured quality is greater than a threshold. For example, a condition may be that a relation (e.g., difference) between a quality of a new best beam/beam group and a quality of reported best beam/beam group is less than a threshold. As an example, the CSI reporting may be triggered where a WTRU 102 reports a new best beam (e.g., via CRI) and a quality difference with the previously reported beam (e.g., CRI) is larger than a threshold. For example, a condition may be that a transmission power associated with recent transmissions (e.g., UL power of any of PUSCH, PUCCH, PRACH and/or SRS) is greater than or equal to a threshold. For example, a condition may be that a measured interference is greater than or equal to a threshold. For example, a condition may be that scheduled traffic is greater than or equal to a threshold. For example, a condition may be that a data arrival rate greater than or equal to threshold. For example, a condition may be that a number of LBT failures greater than or equal to threshold. For example, a condition may be that a priority of recently scheduled transmissions (e.g., any of PUSCHs, PDSCHs, and/or PSSCHs) greater than or equal to threshold.

In certain representative embodiments, a WTRU 102 may report its preferred CSI reporting mode and/or transmission type to a base station (e.g., gNB). For example, the WTRU 102 may report its preferred CSI reporting mode and/or transmission type in a CSI reporting. The CSI reporting may include may include any of the following: (1) a CSI reporting mode, (2) a transmission type, (3) a CSI report configuration ID, (4), a CSI resource configuration ID, (5) a CSI measurement configuration ID, (6) a TRP ID, (7) a panel ID, (8) a RS resource set ID, (9) a resource ID, and/or (10) a WTRU ID.

For example, a WTRU 102 may report and/or indicate (e.g., explicitly or implicitly) its preferred CSI reporting mode (e.g., one of normal CSI or contention-based CSI). For example, the WTRU 102 may report a CSI reporting mode indicator (CMI) to a base station (e.g., gNB) explicitly indicating a CSI reporting mode (e.g., 0 for normal CSI and 1 for contention based CSI). In another example, the CMI may be based on toggling (e.g., where the CMI bit is changed from the previous indication, then a new CSI reporting mode may be preferred, and where the indication bit is the same as with a previous indication, then a previous CSI reporting mode may be still preferred).

For example, a WTRU 102 may report a transmission type indication (TTI) to a base station (e.g., gNB). The TTI may indicate one or more of periodic, semi-persistent, aperiodic and/or contention-based CSI as a transmission type for an associated CSI reporting.

For example, the WTRU 102 may report the configuration/indication indicating one or more CSI report configuration IDs associated with the indicated CSI reporting mode and/or the indicated transmission type.

For example, the WTRU 102 may report the configuration/indication indicating one or more CSI resource configuration IDs associated with the indicated CSI reporting mode and/or the indicated transmission type.

For example, the WTRU 102 may report the configuration/indication indicating one or more CSI measurement configuration IDs associated with the indicated CSI reporting mode and/or the indicated transmission type.

For example, the WTRU 102 may report the configuration/indication indicating one or more TRP IDs associated with the indicated CSI reporting mode and/or the indicated transmission type.

For example, the WTRU 102 may report the configuration/indication indicating one or more panel IDs associated with the indicated CSI reporting mode and/or the indicated transmission type.

For example, the WTRU 102 may report the configuration/indication indicating one or more RS resource set IDs associated with the indicated CSI reporting mode and/or the indicated transmission type.

For example, the WTRU 102 may report the configuration/indication indicating one or more RS resource IDs associated with the indicated CSI reporting mode and/or the indicated transmission type.

For example, the WTRU 102 may report the configuration/indication indicating one or more WTRU IDs associated with the indicated CSI reporting mode and/or the indicated transmission type. As an example, the indication may be included in a group DCI to indicate a CSI reporting mode and/or transmission type to indicate to multiple WTRUs to use the indicated CSI reporting mode and/or the indicated transmission type.

### PUCCH for Contention-Based CSI Reporting

### CSI Report Configuration

In certain representative embodiments, a WTRU 102 may receive one or more CSI report configurations. A CSI report configuration may indicate at least one CSI report quantity including any of a CQI (Channel Quality Information), PMI (Precoding Matrix Indicator), CRI (CSI-RS Resource Indicator), LI (Layer Indicator), and/or RI (Rank Indicator), and the like. For example, a WTRU 102 may be indicated, determine, or be configured with the higher layer parameter CSI-ReportConfig. The WTRU 102 may determine any of the following parameters and/or information: (1) CSI-RS resources and/or CSI-RS resource sets for channel and/or interference measurement, (2) CSI report configuration type (e.g., periodic, semi-persistent, and/or aperiodic), (3) CSI report transmission periodicity (e.g., for periodic and semi-persistent CSI reports), (4) a CSI report transmission offset (e.g., slots, subframes, frames, milliseconds, and/or TTIs), (5) time restrictions for channel and/or interference measurements for the CSI report, (6) a report quantity (CQI, RSRP, SINR, LI, RI, etc.), and/or (7) The codebook configuration, e.g., codebook subset restriction. The foregoing list of parameters is a non-limiting example of the parameters that may be included in the CSI report configuration. One or more of those parameters may be included. Other parameters or choices may be included.

### PUCCH

In certain representative embodiments, a WTRU 102 may be indicated, determine, or be configured with a physical uplink channel to transmit the CSI report. For example, a WTRU 102 may transmit a respective CSI report using uplink control resources (e.g., PUCCH). For example, a WTRU 102 may transmit a respective CSI report on uplink shared resources (e.g., PUSCH). In some embodiments, one or more formats for a PUCCH configuration may be used, configured, and/or determined. FIG. 5 is a chart illustrating example physical uplink control channel (PUCCH) formats (PFs) and associated information. As shown in FIG. 5, PUCCH formats 0, 1, 2, 3, 4, and/or 5 may be associated with respective lengths (e.g., in symbols, such as but not limited to, OFDM symbols, and respective numbers of bits. The chart in FIG. 5 is a non-limiting example of the parameters that may be configured for any (e.g., each) PUCCH format. In some embodiments, one or more of those parameters may be included for a given format. The length in OFDM symbols, number of bits, and/or choices for each parameter are examples. Other lengths in symbols, numbers of bits, and/or choices may be included.

In certain representative embodiments, one or more parameters may be used, configured, or determined per PUCCH format. The configuration parameters may be based on one or more of the following: (1) group and/or sequence hopping, (2) cyclic shift hopping, (3) scrambling, (4) RS(s), and/or channel coding (e.g., cyclic redundancy check (CRC)). For example, one or more parameters may be used, configured, or determined that enable or disable the group and/or sequence hopping and/or determine the respective properties. For example, the frequency hopping properties may be indicated based on a higher layer parameter (e.g., hopping/d). For example, the cyclic shift hopping may be defined based on a symbol and/or a slot index (e.g., number). Cyclic shift hopping may be used in a pseudo-random sequence generator that may be initialized based on one or more parameter (e.g., hopping/d). For example, scrambling may be supported for a PUCCH format. A block of bits may be scrambled before modulation and according to a scrambling sequence that may be initialized based on one or more parameters (e.g., higher layer parameters, such as C-RNTI and/or dataScramblingIdentityPUSCH). In PUCCH formats where RSs (e.g., DMRS) are supported (e.g., PF1, PF2, PF3, and PF4), a DMRS sequence may be transmitted along with a respective PUCCH.

In certain representative embodiments, a PUCCH DMRS may be a reference sequence. For example, PUCCH DMRS may be generated based on Zadoff-Chu sequences, pseudo-random sequences, and/or similar sequences. A scrambling sequence generator used for a sequence corresponding to PUCCH DMRS may be initialized and/or configured based one or more parameters.

For example, in a first PUCCH format (e.g., PF1), a DMRS sequence may be generated based on ZC-sequences, that is:

$${r}_{u , v}^{( α , δ )} ( n ) = {e}^{- j \frac{π qn ( n + 1 )}{{N}_{ZC}}} , 0 \leq n < {N}_{ZC}$$

where N_{ZC} is the ZC-sequence length and root-index (q) is defined based on u and v that may be defined based on higher layer parameters, as follows:

$$q = ⌊ \overline{q} + 1 / 2 ⌋ + v \cdot {( - 1 )}^{⌊ 2 \overline{q} ⌋}$$

$$\overline{q} = {N}_{ZC} \cdot ( u + 1 ) / 31.$$

For example, in a second PUCCH format (e.g., PF2), a DMRS sequence may be generated based on pseudo-random sequences, that is:

$${z}_{l} ( {mN}_{SF}^{PUCCH , 2} + i ) = {w}_{n} ( i ) {r}_{l} ( m )$$

$${r}_{l} ( m ) = \frac{1}{\sqrt{2}} ( 1 - 2 c ( 2 m ) ) + j \frac{1}{\sqrt{2}} ( 1 - 2 c ( 2 m + 1 ) ) , \\ i = 0 , 1 , ... , {N}_{SF}^{PUCCH , 2} - 1 , m = 0 , 1 , ...$$

where, the pseudo-random sequence generator, e.g., c(i) may be initialized with:

$${c}_{init} = ( {2}^{17} ( {N}_{symb}^{slot} {n}_{s , f}^{μ} + l + 1 ) ( 2 {N}_{ID}^{0} + 1 ) + 2 {N}_{ID}^{0} ) mod {2}^{31}$$

where, the index N_{ID}⁰ may be defined based on higher layer parameters e.g., scramblingID0 in the DMRS-UplinkConfig).

For example, in PUCCH formats 3 and 4, DMRS sequences may be generated based ZC-sequences as r_{u,v}^{(α,δ)}(n), where the sequence group u and the sequence number v may be configured based on higher layer parameters (e.g., sequence hopping parameters). The above equations are non-limiting examples of the parameters that may be used to determine a root index, cyclic shift, and/or initialization value of PUCCH DMRS sequences. One or more of those parameters may be included and/or excluded. The coefficients and choices for each parameter are examples. Other coefficients or choices may be included.

For example, one or more channel coding schemes may be used for coding the uplink control information (UCI) that is transmitted (e.g., in PUCCH). For example, coding schemes may be based on block codes and/or polar codes. CRC attachment may be used for a UCI that is transmitted (e.g., in PUCCH). In an example, on condition that a payload size (e.g., in PUCCH) is greater than or equal to a number (e.g., 12), code block segmentation and CRC attachment may be performed.

In some examples, during operation in high frequencies with contention-based CSI reporting, (e.g., some) WTRUs 102 may transmit a CSI report at the same resource blocks causing contention. In certain representative embodiments, the transmitting WTRUs 102 and the contention may be resolved as follows.

In certain representative embodiments, one or more WTRUs 102 may determine or be configured to transmit respective CSI reports in shared and/or common resources (e.g., PUCCH resource blocks). A CSI report transmission from a first WTRU 102 may cause contention on and/or with a CSI report transmission of a second WTRU 102.

As described herein, parameters described such as group and/or sequence hopping, cyclic shift hopping, PUCCH DMRS, scrambling, channel coding (e.g., CRC), and so forth may be referred to as PUCCH parameters. A combination of any such parameters may be referred to as a “PUCCH parameter set”.

In certain representative embodiments, one or more PUCCH parameter sets may be used, defined, configured, and/or determined to identify CSI report transmissions from different WTRUs 102 (e.g., in the respective PUCCH resources). For example, PUCCH parameter sets may be WTRU-specific. As an example, a first PUCCH parameter set may be mutually exclusive to other (e.g., a second) PUCCH parameter sets. One or more PUCCH parameter sets may be configured, indicated and/or determined as part of a PUCCH configuration (e.g., for one or more WTRUs 102).

For example, one or more of the following may apply. A first WTRU 102 may use, define, determine, and/or be configured with a first set of (e.g., WTRU-specific) parameters and/or settings to transmit CSI reporting in respective (e.g., PUCCH) resources. A second WTRU 102 may use, define, determine, and/or be configured with a second set of (e.g., WTRU-specific) parameters and/or settings to transmit CSI reporting in respective (e.g., PUCCH) resources. The network may determine that contention has happened in CSI report transmissions (e.g., in respective PUCCH resources), and the network perform procedures (e.g., to attempt) to resolve the contention. In an example, the CSI report from the first WTRU 102 may be detected, decoded, or recovered based on corresponding first set of WTRU-specific parameters. In an example, the CSI report from the second WTRU 102 may be detected, decoded, or recovered based on corresponding second set of WTRU-specific parameters.

WTRU-Specific Sequences for PUCCH DMRS with Configured IDs

In certain representative embodiments, one or more PUCCH DMRS sequence sets may be used, defined, configured, and/or determined. One or more PUCCH DMRS sequence sets may be configured, such as part of a configuration (e.g., PUCCH configuration). In some embodiments, a first PUCCH DMRS sequence set may be mutually exclusive to other (e.g., a second) PUCCH DMRS sequence sets. A WTRU 102 may use, define, determine, and/or be configured with a PUCCH DMRS sequence set based on a (e.g., corresponding) PUCCH DMRS sequence ID.

As described herein, PUCCH DMRS sequence ID may be used interchangeably with PUCCH DMRS sequence root index, sequence cyclic shift, sequence group, sequence number, and/or sequence initialization value/seed.

In certain representative embodiments, a first WTRU 102 may use, define, determine, and/or be configured with a first set of PUCCH DMRS sequences and/or IDs for contention-based transmission (e.g., in PUCCH resources). A second WTRU 102 may use, define, determine, and/or be configured with a second set of PUCCH DMRS sequences and/or IDs for contention-based transmission in (e.g., in the PUCCH resources). In some embodiments, the first WTRU 102 may use, define, determine, and/or be configured with a third set of PUCCH DMRS sequences and/or IDs for contention-free transmission (e.g., in the PUCCH resources). In some embodiments, the second WTRU 102 may use, define, determine, and/or be configured with a fourth set of PUCCH DMRS sequences and/or IDs for contention-free transmission (e.g., in the PUCCH resources).

In some representative embodiments, orthogonal and/or quasi-orthogonal sequences may be used as the PUCCH DMRS sequences. For example, a first WTRU 102 may be configured with a first PUCCH DMRS sequence based on ZC-sequences with a root index u, and a second WTRU 102 may be configured with a second PUCCH DMRS sequence that may be generated based on a ZC-sequence with a root index w different from the first PUCCH DMRS (e.g., w #u).

For example, in a case a where contention is detected in the CSI reporting (e.g., in the PUCCH resources), the PUCCH DMRS sequences and/or IDs corresponding to each PUCCH transmission may be detected based on the (quasi-)orthogonality of the PUCCH DMRS sequences. As such, the respective PUCCH transmissions from the multiple WTRUs 102 may be detected accordingly.

In certain representative embodiments, contention may be detected in the CSI reporting in the control channel (e.g., PUCCH) resources. The network, base station (e.g., gNB), and/or cell may monitor, receive, attempt to detect and/or decode the (e.g., PUCCH) DMRS sequences that are scrambled with one or more control channel (e.g., PUCCH) transmissions in the control channel (e.g., PUCCH) resources. Upon successful detection of the (e.g., PUCCH) DMRS sequences and/or IDs, the network, base station (e.g., gNB), and/or cell may detect, decode and/or determine the respective WTRUs 102 and corresponding CSI reports, accordingly.

WTRU-Specific CRC Masking Sequences with Configured IDs

In certain representative embodiments, a WTRU 102 may be configured, determine and/or be indicated to use one or more identifying sequences to mask a CRC that is attached to a control channel (e.g., PDCCH) transmission. In an example, one or more WTRU-specific radio network temporary identifiers (RNTIs) may be used as the mask for a CRC. One or more CRC masking sequences used for a (e.g., any or each) PUCCH transmission may be configured as part of a configuration, (e.g., a PUCCH configuration) as described herein. In some embodiments, a WTRU 102 may use, define, determine, and/or be configured with a CRC masking sequence (e.g., in PUCCH) that is based on a configured ID.

In certain representative embodiments, one or more masking sequences for CRC (e.g., in PUCCH) may indicate a mode of transmission (e.g., of the respective PUCCH transmission). For example, a first WTRU 102 may use, define, determine, and/or be configured with a first CRC masking sequence, such as for contention-based transmission (e.g., in PUCCH). A second WTRU 102 may use, define, determine, and/or be configured with a second CRC masking sequence, such as for contention-based transmission (e.g., in PUCCH). In some embodiments, the first WTRU 102 may use, define, determine, and/or be configured with a third CRC masking sequence, such as for contention-free transmission (e.g., in PUCCH). In some embodiments, the second WTRU 102 may use, define, determine, and/or be configured with a fourth CRC masking sequence, such as for contention-free transmission (e.g., in PUCCH).

In certain representative embodiments, orthogonal and/or quasi-orthogonal sequences may be used as the CRC masking sequences in PUCCH. For example, a first WTRU 102 may use, define, determine, and/or be configured with a first CRC masking sequence (e.g., in PUCCH). A second WTRU 102 may use, define, determine, and/or be configured with a second CRC masking sequence (e.g., in PUCCH). The first and/or second CRC masking sequences may be generated based on an ID and/or parameters so that the second CRC masking sequence is different from the first CRC masking sequence (e.g., in PUCCH) used by the first WTRU 102.

For example, in cases where contention in CSI reporting and/or PUCCH transmission takes place, the CRC masking sequence used for the transmission (e.g., of the CSI reporting and/or the PUCCH transmission) may be detected. As such, the respective WTRUs 102 (e.g., associated with the contention) may be detected accordingly.

For example, in a case a where contention is detected in the CSI reporting (e.g., in the PUCCH resources), the network, base station (e.g., gNB), and/or cell may monitor, receive, attempt to detect and/or decode the CRC masking sequence (e.g., in PUCCH). Upon successful detection of a CRC masking sequence (e.g., in a PUCCH transmission), the network, base station (e.g., gNB), and/or cell may detect, decode, and/or determine the respective WTRUs 102 and corresponding CSI reports, accordingly.

WTRU-Specific Scrambling Sequences with Configured IDs

In certain representative embodiments, one or more PUCCH scrambling sequences may be used, defined, configured, and/or determined. One or more PUCCH scrambling sequences may be configured, such as part of a PUCCH configuration, as described herein. A WTRU 102 may use, define, determine, and/or be configured with a PUCCH scrambling sequence based on a higher layer parameter (e.g., a configured parameter and/or ID). For example, a WTRU 102 may use, define, determine, and/or be configured with a PUCCH scrambling sequence based on a (e.g., any) radio network temporary identifier (e.g., WTRU-specific RNTI, contention based CSI RNTI and the like).

In certain representative embodiments, a PUCCH scrambling sequence may indicate a mode of transmission (e.g., for the respective PUCCH). As an example, a first mode may be contention-based transmission and a second mode may be contention-free transmission. For example, a first WTRU 102 may use, define, determine, and/or be configured with a first PUCCH scrambling sequence, such as for contention-based transmission (e.g., in PUCCH). A second WTRU 102 may use, define, determine, and/or be configured with a second PUCCH scrambling sequence, such as for contention-based transmission (e.g., in PUCCH). In some embodiments, the first WTRU 102 may use a third PUCCH scrambling sequence, such as for contention-free transmission (e.g., in PUCCH). In some embodiments, the second WTRU 102 may use a fourth PUCCH scrambling sequence, such as for contention-free transmission (e.g., in PUCCH).

In certain representative embodiments, orthogonal and/or quasi-orthogonal sequences may be used by a WTRU 102 (e.g., as the PUCCH scrambling sequence). For example, a first WTRU 102 may use, define, determine, and/or be configured with a first PUCCH scrambling sequence, and a second WTRU 102 may use, define, determine, and/or be configured with a second PUCCH scrambling sequence that may be generated based on a ID and/or parameters. The first and/or second PUCCH scrambling sequences may be generated based on an ID and/or parameters so that the second PUCCH scrambling sequence is different from the first PUCCH scrambling sequence used by the first WTRU 102.

For example, in a case a where contention is detected in the CSI reporting (e.g., in the PUCCH resources), the network, base station (e.g., gNB), and/or cell may monitor, receive, or attempt to detect and/or decode the PUCCH scrambling sequence. Upon successful detection of PUCCH scrambling sequence, the network, gNB, or cell may detect, decode, and/or determine the respective WTRUs 102 and corresponding CSI reports, accordingly.

WTRU-Specific and/or Group-Specific Hopping Patterns with Configured IDs

In certain representative embodiments, one or more hopping patterns may be used, defined, configured, or determined. For example, one or more PUCCH hopping patterns may be configured, such as part of a PUCCH configuration, as described herein. A PUCCH hopping pattern may be performed across and/or within a set/subset of PUCCH resources (e.g., of a PUCCH resource set), such that frequency hopping transmission occurs with respect to the PUCCH resources. A WTRU 102 may use, define, determine, and/or be configured with a PUCCH hopping pattern based on a higher layer parameter (e.g., a configured parameter and/or ID, such as hopping/d). In certain other embodiments, a hopping pattern may be used, defined, configured, or determined to channels other than PUCCH.

In certain representative embodiments, a PUCCH hopping patterns may indicate a mode of transmission (e.g., for the respective PUCCH transmission). As an example, a first mode may be contention-based transmission and a second mode may be contention-free transmission. For example, a first WTRU 102 may use, define, determine, and/or be configured with a first PUCCH hopping pattern, such as for contention-based transmission (e.g., in PUCCH). A second WTRU 102 may use, define, determine, and/or be configured with a second PUCCH hopping pattern, such as for contention-based transmission (e.g., in PUCCH). In some embodiments, the first WTRU 102 may use a third PUCCH hopping pattern, such as for contention-free transmission (e.g., in PUCCH). In some embodiments, the second WTRU 102 may use a fourth PUCCH hopping pattern, such as for contention-free transmission (e.g., in PUCCH).

In certain representative embodiments, orthogonal and/or quasi-orthogonal sequences may be used as the PUCCH hopping pattern. For example, a first WTRU 102 may use, define, determine, and/or be configured with a first PUCCH hopping pattern, and a second WTRU 102 may use, define, determine, and/or be configured with a second PUCCH hopping pattern that may be generated based on a ID and/or parameters. The first and/or second PUCCH hopping pattern may be generated based on an ID and/or parameters so that the second PUCCH hopping pattern is different from the first PUCCH hopping pattern used by the first WTRU 102.

For example, in a case a where contention is detected in the CSI reporting (e.g., in the PUCCH resources), the network, base station (e.g., gNB), and/or cell may monitor, receive, attempt to detect and/or decode the PUCCH hopping pattern. Upon successful detection of a PUCCH hopping pattern, the network, gNB, and/or cell may detect, decode, and/or determine the respective WTRUs 102 and corresponding CSI reports, accordingly.

Identification with Associated PRACH and/or Scheduling Request

In certain representative embodiments, a WTRU 102 may use one or more PRACH configurations. As an example, one or more WTRU-specific preambles may be used in PRACH transmission. One or more PRACH preambles may be configured as part of PRACH configuration. A WTRU 102 may use, define, determine, or be configured with a PRACH preamble. The PRACH preamble may be based on a configured ID. As an example, a 2-step and/or 4-step random access procedure may be used in PRACH transmission. The 2-step and/or 4-step random-access procedure may be configured, such as part of a PRACH configuration. A WTRU 102 may use, define, determine, and/or be configured with 2-step or 4-step random-access procedure based on a configured ID.

In certain representative embodiments, parameters used for a scheduling request (SR), such as random access parameters, PRACH preamble, 2-step and/or 4-step RA procedure, PUSCH resources (e.g., associated with a configured grant), SR based on random-access and/or PUCCH, may be referred to as scheduling request parameters. A specific combination of such parameters may be referred to as a “SR parameter set”.

In certain representative embodiments, a SR parameter set may be used to indicate and/or identify a WTRU 102 that has performed a random-access procedure and/or a SR transmission. For example, a first WTRU 102 may use, define, determine, and/or be configured with a first SR parameter set. A second WTRU 102 may use, define, determine, and/or be configured with a second SR parameter set. For example, during a random-access procedure, in a case where a first SR parameter set is detected (e.g., by a base station), it can be determined (e.g., by the base station) that the first WTRU 102 has performed a random-access (e.g., PRACH) transmission and/or SR transmission. For example, in a case where a second SR parameter set is detected (e.g., by the base station), it can be determined that the second WTRU 102 has performed a random-access (e.g., PRACH) transmission and/or a SR transmission.

In certain representative embodiments, a PRACH preamble may be used to indicate and/or identify a WTRU 102 that has performed the PRACH transmission. For example, a first WTRU 102 may use, define, determine, and/or be configured with a first PRACH preamble. A second WTRU 102 may use, define, determine, and/or be configured with a second PRACH preamble. During a random-access procedure, in cases where the first preamble is detected, it can be determined that the first WTRU 102 has performed a random-access (e.g., PRACH) transmission. In cases where the second preamble is detected, it can be determined that the second WTRU 102 has performed random-access (e.g., PRACH) transmission.

In certain representative embodiments, a WTRU 102 may perform a random-access procedure for a scheduling request (SR) to transmit CSI report, which may use a contention-based CSI reporting configuration (e.g., a contention-based mode). For example, in cases where a contention in CSI reporting and/or PUCCH transmission takes place, the SR parameter set that was used in a respective SR transmission may be detected. As such, the respective WTRUs 102 and/or SRs may be detected accordingly (e.g., resolved).

For example, in cases where a contention is detected in the CSI reporting, the network, base station (e.g., gNB), and/or cell may monitor, receive, attempt to detect and/or decode the respective random-access procedure and/or scheduling request to detect a SR parameter set (e.g., from among multiple configured SR parameter sets). Upon successful detection of a respective SR parameter set, the network, base station (e.g., gNB), and/or cell may detect, decode, and/or determine a respective WTRU 102 and corresponding CSI report, accordingly.

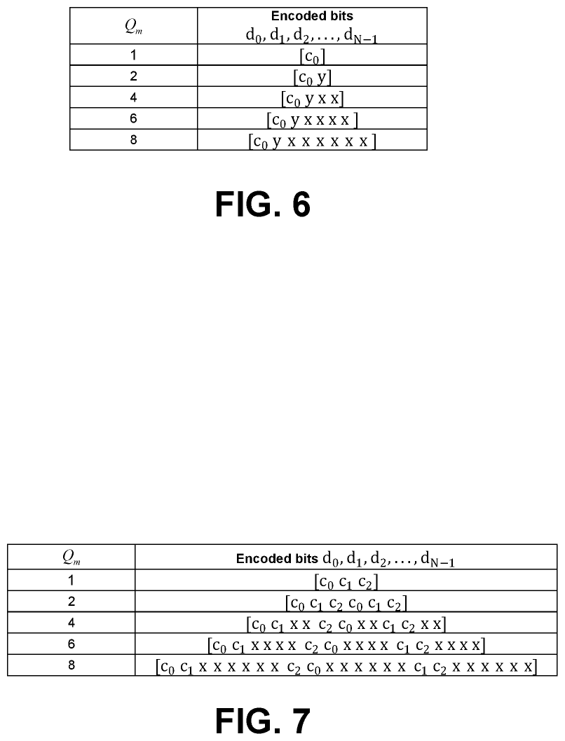

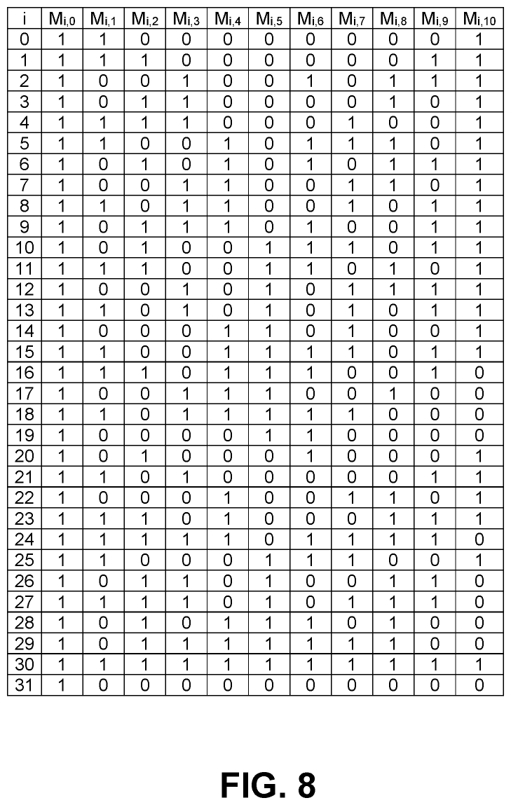

In certain representative embodiments, any of the following methods may be supported for (e.g., PUCCH) transmissions of contention-based CSI reporting. For example, methods and/or procedures for contention-based reporting and/or resolution thereof may use any of code block segmentation, CRC attachment, and/or control information coding. FIG. 6 is a chart illustrating an example of block code for encoding 1-bit of information. FIG. 7 is a chart illustrating an example of block code for encoding 2-bits of information. FIG. 8 is a chart illustrating an example of basis sequences of a (32, K) Reed-Muller code for encoding information.

In some embodiments, various code block segmentation and/or CRC attachment methods may be used (e.g., by a WTRU 102). For example, for normal CSI reporting (e.g., a first mode of operation), WTRU CRC attachment may be based on payload size. As an example, CRC attachment may be based on any of the following: (1) if a payload size (e.g., for PUCCH) is less than or equal to a first threshold (e.g., 12 bits), then a first number (e.g., 0 or no CRC bits) of CRC bits may be used for the CRC; (2) if the payload size is greater than or equal to the first threshold and less than or equal to a second threshold (e.g., 19 bits), then a second number of CRC bits may be used (e.g., 6 bits or g_{CRC6(D)} as described in 3GPP TS 38.212); and/or (3) if the payload size is greater than (or equal to) the second threshold (e.g., 20 bits), then a third number of CRC bits may be used (e.g., 11 bits or g_{CRC11(D)} in as described in 3GPP TS 38.212). For example, for contention-based CSI reporting (e.g., a second mode of operation), WTRU CRC attachment may be based on any of the following: (1) if a payload size (e.g., for PUCCH) is less than or equal to a first threshold (e.g., 12 bits), then a first number (e.g., X CRC bits) of CRC bits may be used for the CRC; (2) if the payload size is greater than or equal to the first threshold and less than or equal to a second threshold (e.g., 19 bits), then a second number of CRC bits may be used (e.g., Y bits, such as where Y is greater than or equal to X); and/or (3) (2) if the payload size is greater than (or equal) to the second threshold (e.g., 20 bits), then a third number of CRC bits may be used (e.g., Z bits where Z is greater than or equal to Y).

In certain representative embodiments, various control information coding methods may be used (e.g., by a WTRU 102). For example, for normal CSI reporting (e.g., a first mode of operation), channel coding to be applied may be based on payload size. For example, for contention-based CSI reporting (e.g., a second mode of operation), one or more different channel coding approaches may be applied, and which may also be based on payload size. As an example, UCI channel coding may be based on any of the following: (1) if a payload size (e.g., for PUCCH) is less than a first threshold (e.g., 2 bits), than a first type of code (e.g., block code) may be used; (2) if the payload size (e.g., for PUCCH) is greater than the first threshold and less than or equal to a second threshold (e.g., 11 bits), than a second type of code (e.g., Reed-Muller code) may be used; and (3) if the payload size (e.g., for PUCCH) is greater than the second threshold (e.g., 12 bits), than a third type of code (e.g., a polar code) may be used.

As an example, for normal CSI reporting, coding of a transmission (e.g., a PUCCH transmission) may be based on any of: (1) if a payload size of the transmission is less than or equal to 2 bits, block codes as shown in FIGS. 6 and/or 7 may be used; (2) if the payload size of the transmission is greater than 2 bits and less than or equal to 11 bits, a Reed-Muller code may be used, such as shown in FIG. 8; and (3) if the payload size is greater than 12 bits, a polar code may be used. In some embodiments, coding types, such as those examples shown in FIGS. 6, 7 and/or 8, may be used for any of normal CSI reporting and/or contention-based CSI reporting.

In certain representative embodiments, for contention based CSI reporting, at least one different WTRU channel coding method may be used as compared to normal (e.g., non-contention based CSI reporting). For example, channel coding by a WTRU 102 may be based on any of the following: (1) if a payload size of a transmission (e.g., a PUCCH transmission) is less than or equal to a first threshold, then a first code type may be used, (2) if the payload size is greater than (or equal to) the first threshold and less than or equal to a second threshold, a first or second code type may be used; and (3) if the payload size is greater than (or equal to) the second threshold, a second (or third) code type may be used.

As an example, for contention based CSI reporting, at least one different WTRU channel coding method may be used as compared to normal (e.g., non-contention based CSI reporting). For example, channel coding by a WTRU 102 may be based on any of the following: (1) if a payload size of a transmission (e.g., a PUCCH transmission) is less than or equal to 2 bits, then Reed-Muller code or polar code may be used, (2) if the payload size is greater than (or equal to) 3 bits and less than or equal to 11 bits, a Reed-Muller code or polar code may be used; and (3) if the payload size is greater than (or equal to) 12 bits, a polar code may be used.

As described above, Reed-Muller codes and/or polar codes may be used for channel coding (e.g., by a WTRU 102). In other representative embodiments, any of convolutional codes, LDPC codes and/or turbo codes may be used instead of the Reed-Muller codes and/or the polar codes.

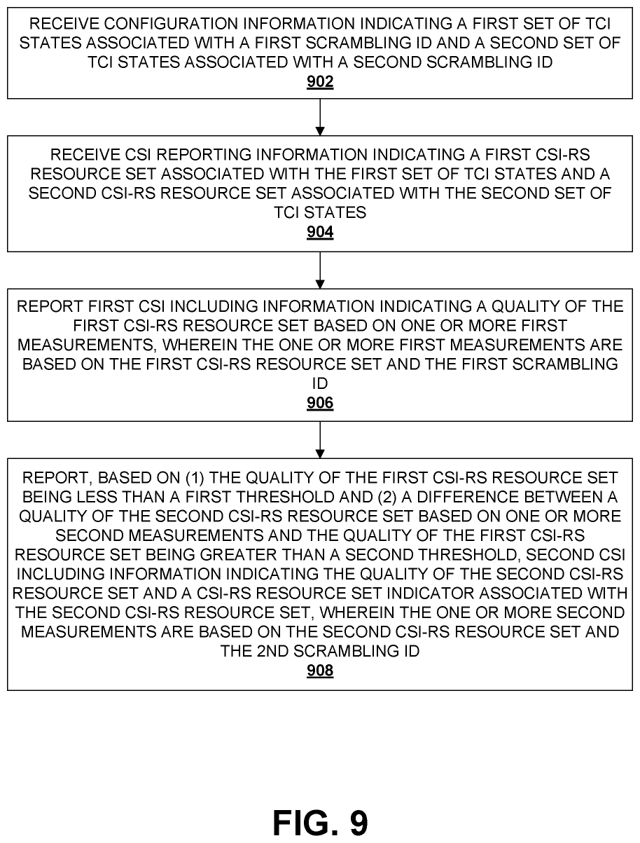

FIG. 9 is a procedural diagram illustrating an example procedure for reporting CSI for multiple CSI-RS resource sets. The procedure shown in FIG. 9 may be implemented (e.g., as a method or apparatus) by a WTRU 102 in communication with a base station, such as a gNB 180. In FIG. 9, a WTRU 102 may receive (e.g., from a base station) configuration information indicating a first set of TCI states associated with a first scrambling ID and a second set of TCI states associated with a second scrambling ID at 902. At 904, the WTRU 102 may receive (e.g., from the base station) CSI reporting information indicating a first CSI-RS resource set associated with the first set of TCI states and a second CSI-RS resource set associated with the second set of TCI states. At 906, the WTRU 102 may report (e.g., to the base station) first CSI including information indicating a quality of the first CSI-RS resource set based on one or more first measurements. The one or more first measurements may be based on (e.g., performed using) the first CSI-RS resource set and the first scrambling ID. At 910, the WTRU 102 may report (e.g., to the base station), based on (1) the quality of the first CSI-RS resource set being less than a first threshold and (2) a difference between a quality of the second CSI-RS resource set based on one or more second measurements and the quality of the first CSI-RS resource set being greater than a second threshold, second CSI including information indicating the quality of the second CSI-RS resource set and a CSI-RS resource set indicator associated with the second CSI-RS resource set. For example, the one or more second measurements may be based on (e.g., performed using) the second CSI-RS resource set and the 2nd scrambling ID.

In certain representative embodiments, the first scrambling ID may be different than the second scrambling ID. For example, the WTRU 102 may perform the first measurements using the first CSI-RS resource set and the first scrambling ID which is associated with the first set of TCI states. For example, the base station may transmit CSI-RSs using the first CSI-RS resource set, and the transmitted CSI-RSs may be scrambled using the first scrambling ID. The WTRU 102 may also perform the second measurements using the second CSI-RS resource set and a different (e.g., second) scrambling ID which is associated with the second set of TCI states. For example, the base station may transmit CSI-RSs using the second CSI-RS resource set, and the transmitted CSI-RSs may be scrambled using the second scrambling ID.

In certain representative embodiments, the first measurements may be performed by the WTRU 102 using at least one TCI state of the first set of TCI states.

In certain representative embodiments, the second measurements may be performed using at least one TCI state of the second set of TCI states. For example, a TCI state used for the first measurements may be different than a TCI state used for the second measurements.

In certain representative embodiments, the respective TCI states of the first set of TCI states may (e.g., each) be different than the respective TCI states of the second set of TCI states.

In certain representative embodiments, at least one TCI state of the first set of TCI states may be the same as at least one TCI states of the second set of TCI states.

In certain representative embodiments, the WTRU 102 may activate the second CSI-RS resource set and/or deactivate the first CSI-RS resource set based on the quality of the first CSI-RS resource set being less than the first threshold.

In certain representative embodiments, the WTRU 102 may receive a physical downlink control channel (PDCCH) transmission using a TCI state of the second set of TCI states. For example, the WTRU 102 may activate the second CSI-RS resource set and/or deactivate the first CSI-RS resource set based on (e.g., after receiving) the PDCCH transmission. In some embodiments, the PDCCH transmission may include information indicating the activation of the second CSI-RS resource set.

In certain representative embodiments, the WTRU 102 may determine one or more TCI states of the first set of TCI states, and perform the first measurements using the first CSI-RS resource set, the first scrambling ID, and the determined one or more TCI states (e.g., of the first set of TCI states).

In certain representative embodiments, the WTRU 102 may determine one or more TCI states of the second set of TCI states, and perform the second measurements using the second CSI-RS resource set, the first scrambling ID, and the determined one or more TCI states (e.g., of the first set of TCI states).

In certain representative embodiments, the WTRU 102 may receive information indicating a third set of TCI states associated with a third scrambling ID. For example, the third set of TCI states may be provided at 902 in FIG. 9. The WTRU 102 may perform third measurements using the second CSI-RS resource set and the third scrambling ID associated with the third set of TCI states. The WTRU 102 may proceed to report CSI including information indicating the quality of the second CSI-RS resource set (e.g., based on the third measurements) and a CSI-RS resource set indicator of the second CSI-RS resource set.

In certain representative embodiments, the quality of the first CSI-RS resource set may be determined using any of a maximum measurement value, a minimum measurement value, and/or an average measurement value of the first measurements, and/or the quality of the second CSI-RS resource set is associated with any of a maximum measurement value, a minimum measurement value, and/or an average measurement value of the second measurements. In other representative embodiments, the quality may otherwise be determined as described herein.

In certain representative embodiments, the quality may be, or include, any of a channel quality indicator (CQI), a signal to interference plus noise ratio (SINR), or a reference signal received power (RSRP) value. In other representative embodiments, the quality may be, or include, other parameters as described herein.

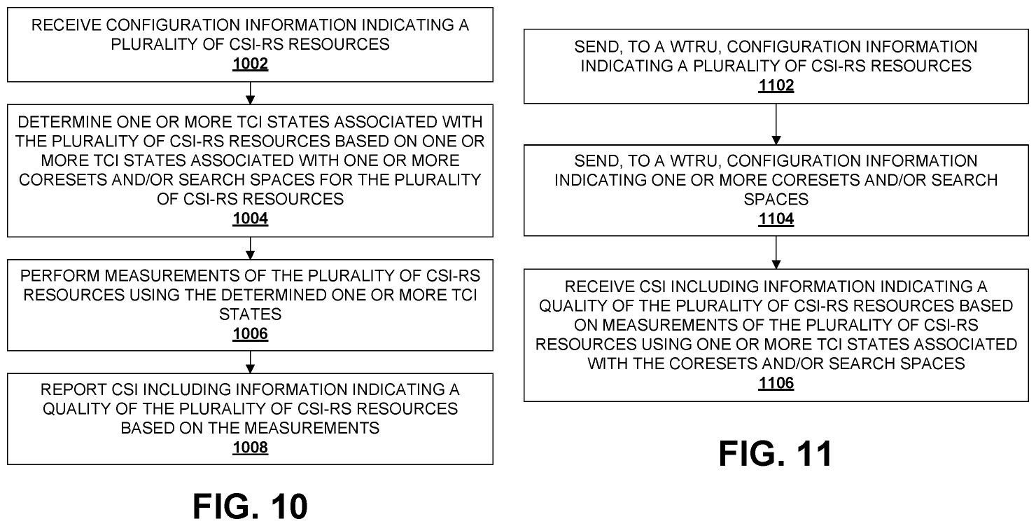

FIG. 10 is a procedural diagram illustrating an example procedure for reporting CSI for multiple CSI-RS resources using determined TCI states. The procedure shown in FIG. 10 may be implemented (e.g., as a method or apparatus) by a WTRU 102 in communication with a base station, such as a gNB 180. In FIG. 10, a WTRU 102 may receive (e.g., from a base station) configuration information indicating a plurality of CSI-RS resources (e.g., a resource set or sets of resources) at 1002. At 1004, the WTRU 102 may determine one or more TCI states associated with the plurality of CSI-RS resources. The determination may be based on one or more TCI states associated with one or more CORESETs and/or search spaces (e.g., associated with the plurality of CSI-RS resources or otherwise configured at the WTRU 102). For example, the WTRU 102 may determine the one or more TCI states (e.g., to be used) for the CSI-RS resources based on the one or more TCI states (e.g., used or to be used) for the CORESETs and/or for the search spaces. The WTRU 102 may perform measurements of (e.g., at least a portion of) the plurality of CSI-RS resources using the determined one or more TCI states at 1006. At 1008, the WTRU 102 may report (e.g., to the base station) CSI including information indicating a quality of the plurality of CSI-RS resources based on the measurements.

In certain representative embodiments, the WTRU 102 may receive (e.g., from a base station) configuration information indicating the CORESETs and/or search spaces.

In certain representative embodiments, the WTRU 102 may receive (e.g., from a base station) control signaling in (e.g., using resources configured in) one of the CORESETs and/or search spaces. The one or more TCI states may be determined based on one or more TCI states associated with the one of the CORESETs and/or search spaces in which the control signaling is received.

In certain representative embodiments, any (e.g., each) of the one or more TCI states may be respectively associated with one of the one or more CORESETs and/or search spaces.

In certain representative embodiments, at least one of the one or more TCI states associated with the plurality of CSI-RS resources may be the same as at least one of the one or more TCI states associated with the one of the CORESETs and/or search spaces.

In certain representative embodiments, the WTRU 102 may perform the one or more measurements of the plurality of CSI-RS resources using the determined one or more TCI states and a (e.g., at least one) scrambling ID associated with the one or more TCI states.

In certain representative embodiments, the quality of the plurality of CSI-RS resources may be associated with (e.g., determined using) any of a maximum measurement value, a minimum measurement value, and/or an average measurement value of the measurements. In other representative embodiments, the quality may otherwise be determined as described herein.

In certain representative embodiments, the quality may be, or include, any of a channel quality indicator (CQI), a signal to interference plus noise ratio (SINR), or a reference signal received power (RSRP) value. In other representative embodiments, the quality may be, or include, other parameters as described herein.

In certain representative embodiments, the WTRU 102 may receive control signaling in one of the CORESETs and/or search spaces which includes information to trigger the reporting of the CSI.

In certain representative embodiments, the plurality of CSI-RS resources may be arranged in or as one or more CSI-RS resource sets.

FIG. 11 is a procedural diagram illustrating an example procedure for receiving CSI using WTRU-determined TCI states. The procedure shown in FIG. 11 may be implemented (e.g., as a method or apparatus) by a base station, such as a gNB 180, in communication with a WTRU 102. At 1102, the base station may send, to a WTRU 102, configuration information indicating a plurality of CSI-RS resources. At 1104, the base station may send, to the WTRU, configuration information indicating one or more control resource sets (CORESETs) and/or search spaces. At 1106, the base station may receive, from the WTRU 102, CSI including information indicating a quality of the plurality of CSI-RS resources based on measurements of the plurality of CSI-RS resources by the WTRU 102 using one or more TCI states associated with the one or more CORESETs and/or search spaces.

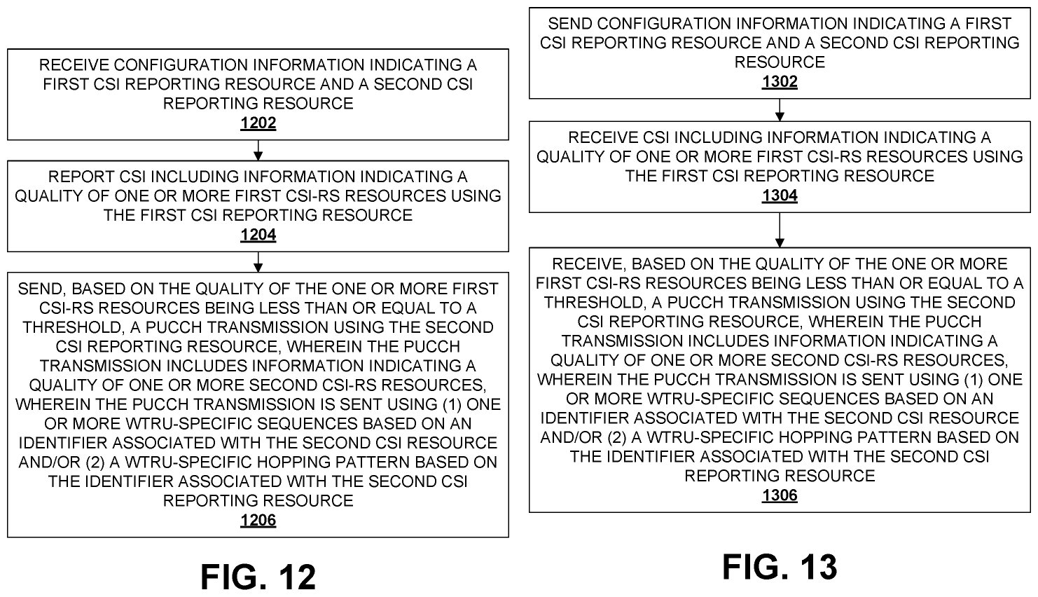

FIG. 12 is a procedural diagram illustrating an example procedure for reporting CSI using a physical uplink control channel (PUCCH) transmission. The procedure shown in FIG. 12 may be implemented (e.g., as a method or apparatus) by a WTRU 102 in communication with a base station, such as a gNB 180. As shown in FIG. 12, a WTRU 102 may receive (e.g., from a base station) configuration information indicating a first CSI reporting resource and a second CSI reporting resource at 1202. At 1204, the WTRU 102 may report (e.g., to the base station) CSI including information indicating a quality of one or more first CSI-RS resources using the first CSI reporting resource. For example, the WTRU 102 may perform measurements using the one or more first CSI-RS resources as described herein. At 1206, the WTRU 102 may send (e.g., to the base station), based on the quality of the one or more first CSI-RS resources being less than or equal to a threshold, a PUCCH transmission using the second CSI reporting resource. The PUCCH transmission may include information indicating a quality of one or more second CSI-RS resources. For example, the WTRU 102 may perform second measurements using the one or more second CSI-RS resources as described herein. For example, the PUCCH transmission may be sent using (1) one or more WTRU-specific sequences based on an identifier associated with the second CSI resource and/or (2) a WTRU-specific hopping pattern based on the identifier associated with the second CSI reporting resource.

In certain representative embodiments, the first CSI reporting resource may be associated non-contention-based CSI reporting and the second CSI reporting resource may be associated with contention-based CSI reporting.

In certain representative embodiments, the WTRU 102 may perform the first measurements using the one or more first CSI-RS resources, and the CSI reported using the first CSI reporting resource may be based on the first measurements.

In certain representative embodiments, the WTRU 102 may perform second measurements using the one or more second CSI-RS resources, and the CSI reported using the second CSI reporting resource is based on the second measurements.

In certain representative embodiments, the WTRU 102 may receive information indicating a reporting mode associated with the first CSI reporting resource. For example, a non-contention-based mode of reporting may be associated with (e.g., indicated for) the first CSI reporting resource. For example, a contention-based mode of reporting may be associated with (e.g., indicated for) the second CSI reporting resource.

In certain representative embodiments, the WTRU 102 may determine to use a reporting mode associated with the first (or second) CSI reporting resource based on the received configuration information.

In certain representative embodiments, the WTRU-specific hopping pattern is any of a frequency hopping pattern, a group hopping pattern, a sequence hopping pattern, and/or cyclic shift hopping pattern.

In certain representative embodiments, the one or more WTRU-specific sequences include any of a PUCCH demodulation reference signal (DMRS) sequence, and/or a cyclic redundancy check (CRC) masking sequence, a PUCCH scrambling sequence.

In certain representative embodiments, the WTRU 102 may receive information indicating the identifier associated with the second CSI reporting resource (e.g., prior to measuring the second CSI-RS resources).

In certain representative embodiments, the WTRU 102 may receive information indicating a first CSI-RS resource set which includes the one or more first CSI-RS resources and/or a second CSI resource set which includes the one or more second CSI-RS resources.

In certain representative embodiments, the quality may be, or include, any of a channel quality indicator (CQI), a signal to interference plus noise ratio (SINR), or a reference signal received power (RSRP) value. In other representative embodiments, the quality may be, or include, other parameters as described herein.

FIG. 13 is a procedural diagram illustrating an example procedure for receiving CSI using a physical uplink control channel (PUCCH) transmission. The procedure shown in FIG. 13 may be implemented (e.g., as a method or apparatus) by a base station, such as a gNB 180, in communication with a WTRU 102. As shown in FIG. 13, a base station may send (e.g., to a WTRU 102) configuration information indicating a first CSI reporting resource and a second CSI reporting resource at 1302. At 1304, the base station may receive (e.g., from the WTRU 102) CSI including information indicating a quality of one or more first CSI-RS resources using the first CSI reporting resource. At 1306, the base station may receive (e.g., from the WTRU 102), based on the quality of the one or more first CSI-RS resources being less than or equal to a threshold, a PUCCH transmission using the second CSI reporting resource. For example, the PUCCH transmission may include information indicating a quality of one or more second CSI-RS resources. The PUCCH transmission may be sent by the WTRU 102 using (1) one or more WTRU-specific sequences based on an identifier associated with the second CSI resource and/or (2) a WTRU-specific hopping pattern based on the identifier associated with the second CSI reporting resource.

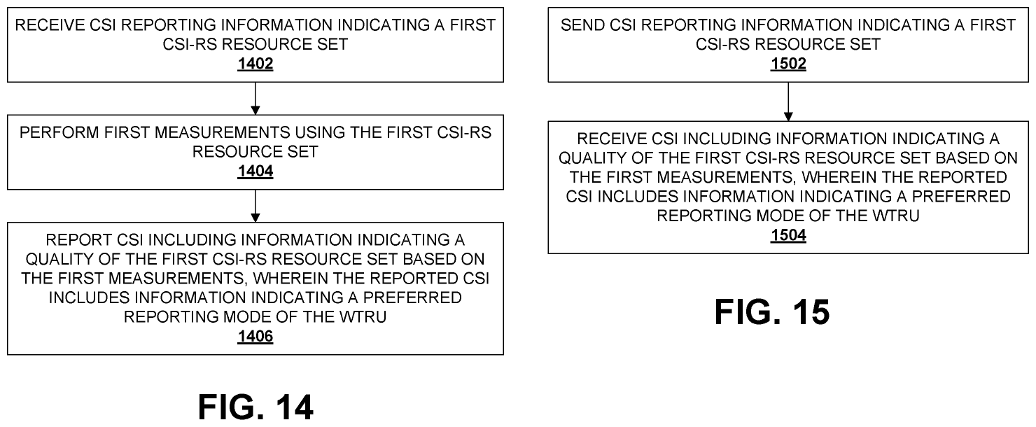

FIG. 14 is a procedural diagram illustrating an example procedure for reporting CSI and a preferred reporting mode of a WTRU. The procedure shown in FIG. 14 may be implemented (e.g., as a method or apparatus) by a WTRU 102 in communication with a base station, such as a gNB 180. As shown in FIG. 14, a WTRU 102 may receive (e.g., from a base station) CSI reporting information indicating a first CSI-RS resource set at 1402. At 1404, the WTRU 102 may perform first measurements using the first CSI-RS resource set. At 1406, the WTRU 102 may report (e.g., to the base station) CSI including information indicating a quality of the first CSI-RS resource set based on the first measurements, wherein the reported CSI includes information indicating a preferred reporting mode of the WTRU. For example, the WTRU 102 may determine the preferred reporting mode based on any of an amount of measured interference, an amount of scheduled traffic, a data arrival rate, and/or a number of listen-before-talk (LBT) failures.

In certain representative embodiments, the preferred reporting mode may be any non-contention-based CSI reporting or contention-based CSI reporting.

In certain representative embodiments, the WTRU 102 may receive (e.g., from the base station) configuration information indicating a first CSI reporting resource and a second CSI reporting resource.

In certain representative embodiments, the WTRU 102 may report (e.g., to the base station) the CSI using the first CSI reporting resource based on the quality of the first CSI-RS resource set being greater than a threshold.

In certain representative embodiments, the WTRU 102 may report (e.g., to the base station) the CSI using the second CSI reporting resource based on the quality of the first CSI-RS resource set being less than a threshold.

In certain representative embodiments, the WTRU 102 may send (e.g., to the base station) a PUCCH transmission using the second CSI reporting resource. For example, the PUCCH transmission may include information indicating the reported CSI. The WTRU 102 may apply one or more WTRU-specific sequences and/or patterns to the PUCCH transmission as described herein.

In certain representative embodiments, the WTRU 102 may indicate the preferred reporting mode via an explicit bit field value of the CSI. For example, a bit value may be set to 0 to indicate a preference for normal CSI reporting or may be set to 1 to indicate a preference for contention-based CSI reporting.

In certain representative embodiments, the WTRU 102 may indicate the preferred reporting mode via toggling a bit field value of the CSI. For example, a bit value may be set to remain the same as a previous value to indicate a preference for normal CSI reporting or may be changed from a previous value to indicate a preference for contention-based CSI reporting.

In certain representative embodiments, the information indicating the preferred reporting mode may be a reporting mode indicator (RMI). In certain representative embodiments, the information indicating the preferred reporting mode may be a CSI reporting mode indicator (CMI).

FIG. 15 is a procedural diagram illustrating an example procedure for receiving CSI and a preferred reporting mode of a WTRU. The procedure shown in FIG. 15 may be implemented (e.g., as a method or apparatus) by a base station, such as a gNB 180, in communication with a WTRU 102. As shown in FIG. 15, a base station may send (e.g., to a WTRU 102) CSI reporting information indicating a first CSI-RS resource set at 1502. At 1504, the base station may receive (e.g., from the WTRU 102) CSI including information indicating a quality of the first CSI-RS resource set based on the first measurements. The reported CSI may include information indicating a preferred reporting mode of the WTRU 102 as described herein.

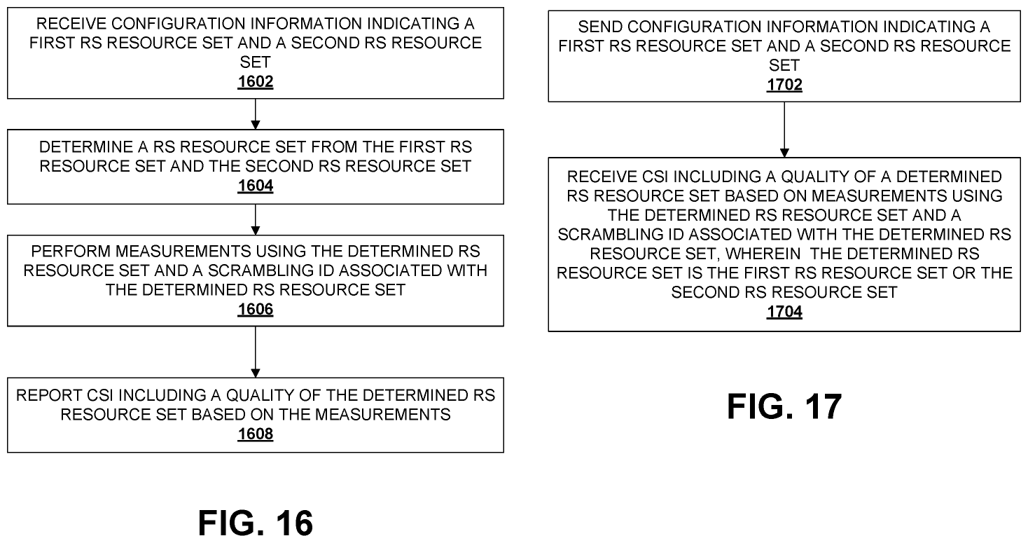

FIG. 16 is a procedural diagram illustrating an example procedure for reporting CSI. The procedure shown in FIG. 16 may be implemented (e.g., as a method or apparatus) by a WTRU 102 in communication with a base station, such as a gNB 180. As shown in FIG. 16, a WTRU 102 may receive (e.g., from a base station) configuration information indicating a first RS resource set and a second RS resource set at 1602.

The WTRU 102 may determine a RS resource set from the first RS resource set and the second RS resource set at 1604. At 1606, the WTRU 102 may perform measurements using the determined RS resource set and a scrambling ID associated with the determined RS resource set. At 1608, the WTRU 102 may report CSI including a quality of the determined RS resource set based on the measurements. For example, the WTRU 102 may report the CSI at 1608 using contention-based reporting and/or non-contention-based reporting as described herein.

In certain representative embodiments, the WTRU 102 may determine to use a contention-based reporting resource based on the quality of the determined RS resource set being less than or equal to a threshold.

In certain representative embodiments, the WTRU 102 may determine to use a non-contention-based reporting resource based on the quality of the determined RS resource set being greater a threshold.

In certain representative embodiments, the reported CSI may include information indicating a preferred reporting mode of the WTRU.

In certain representative embodiments, the WTRU 102 may determine the scrambling ID based on an association of the determined RS resource set with a set of TCI states.

In certain representative embodiments, the WTRU 102 may determine a TCI state (e.g., to use at 1606 for the measurements) among the set of TCI states based on a CORESET and/or search space associated with the determined RS resource set.

FIG. 17 is a procedural diagram illustrating an example procedure for receiving CSI. The procedure shown in FIG. 17 may be implemented (e.g., as a method or apparatus) by a base station, such as a gNB 180, in communication with a WTRU 102. As shown in FIG. 17, a base station may send (e.g., to a WTRU 102) configuration information indicating a first RS resource set and a second RS resource set at 1702. At 1704, the base station may receive (e.g., from a WTRU 102) CSI including a quality of a determined RS resource set based on measurements using the determined RS resource set and a scrambling ID associated with the determined RS resource set, wherein the received CSI is received using a contention-based reporting resource or a non-contention-based reporting resource, and the determined RS resource set is the first RS resource set or the second RS resource set.

In certain representative embodiments, a WTRU 102 may receive information indicating at least a first RS resource set and a second RS resource set which are associated with a plurality of non-orthogonal RSs. The WTRU 102 may receive information indicating a beam reporting configuration associated with the first RS resource set and the second RS resource set. The WTRU 102 may receive information indicating a first measurement configuration associated with the first RS resource set and a second measurement configuration associated with the second RS resource set. The WTRU 102 may measure at least one of the non-orthogonal RSs with the first RS resource set according to the first measurement configuration and at least one of the non-orthogonal RSs with the second RS resource set according to the second measurement configuration. The WTRU 102 may, on condition that the measuring of at least one of the non-orthogonal RSs using the first RS resource set satisfies one or more conditions, send a transmission, according to the beam reporting configuration, which includes measurement information (e.g., CSI) associated with the measuring of the at least one of the non-orthogonal RSs and information indicating the measurement information is associated with a change to the second RS resource set.

In certain representative embodiments, the first RS resource set may be associated with a first beam group and a second beam group. The second RS resource set may be associated with a third beam group and a fourth beam group.

In certain representative embodiments, the plurality of non-orthogonal RSs of at least two of the first, second, third and fourth beam groups may be transmitted and/or received at a same time.

In certain representative embodiments, the measurement of at least one of the non-orthogonal RSs with the first RS resource set and the first beam group may be more frequent (e.g., more frequently performed) than the measurement of the at least one of the non-orthogonal RSs with the first RS resource set and the second beam group.

In certain representative embodiments, the measurement of at least one of the non-orthogonal RSs with the first RS resource set may be more frequent (e.g., more frequently performed) than the measurement of the at least one of the non-orthogonal RSs with the second RS resource set.

In certain representative embodiments, the WTRU 102 may receive a transmission including information indicating a confirmation associated with the change to the second RS resource set.

In certain representative embodiments, the WTRU 102 may receive information indicating a transmission configuration of a source RS. The WTRU 102 may determine one or more QCL parameters from the source RS. The measuring of the at least one of the non-orthogonal RSs with the first RS resource set and/or the at least one of the non-orthogonal RSs with the second RS resource set may use the determined one or more QCL parameters.

In certain representative embodiments, the information indicating the measurement information associated with the change to the second RS resource set may be any of a RS resource set identifier, a RS identifier, or a toggle.

In certain representative embodiments, the one or more conditions may include any of: (1) a quality associated with measurement using the first resource set being less than or equal to a threshold, (2) a quality associated with measurement using the first resource set and a first beam group being less than or equal to a quality associated with measurement using the first resource set and a second beam group, and/or (3) a quality associated with measurement using the second resource set being greater than or equal to quality associated with measurement using the first resource set.

In certain representative embodiments, the quality associated with measurement using the first resource set may include any of a reference signal received power, a signal and interference to noise ratio, a channel quality indicator, a layer indicator, a rank indicator, a precoding matrix indicator, and/or a channel resource indicator.

In certain representative embodiments, the quality associated with measurement using the first resource set may be based on any of a minimum value, a maximum value, and/or an average value.

In certain representative embodiments, a WTRU 102 may receive information indicating a configuration of common reporting resources. The WTRU 102 may measure one or more RSs. On condition that a reporting mode indication to use the common reporting resources has been received by the WTRU 102, the WTRU 102 may process a transmission which includes measurement information associated with the measuring of the one or more RSs, and send the transmission using the common reporting resources.

In certain representative embodiments, the processing of the transmission may include any of: (1) adding a demodulation RS (DMRS) sequence associated with the WTRU to the transmission, (2) masking cyclic redundancy check bits of the transmission using a masking sequence associated with the WTRU, (3) scrambling the transmission with a scrambling sequence associated with the WTRU, (4) mapping the transmission to the common reporting resources using a hopping pattern associated with the WTRU, and/or (5) applying a scheduling request (SR) parameter set associated with the WTRU to the transmission.

For example, the WTRU 102 may receive information indicating the DMRS sequence identifier, determine the DMRS sequence using the DMRS sequence identifier.

For example, the WTRU 102 may receive information indicating a RNTI associated with the WTRU 102, and determine the masking sequence using the RNTI.

For example, a WTRU 102 may receive information indicating a configuration associated with the WTRU 102, and determine the scrambling sequence using one or more parameters of the configuration.

For example, a WTRU 102 may receive information indicating a configuration associated with the WTRU 102, and determine the hopping pattern using one or more parameters of the configuration.

For example, a WTRU 102 may receive information indicating a configuration associated with the WTRU 102, and determine the SR parameter set using one or more parameters of the configuration.

In certain representative embodiments, the processing of the transmission may include to determine a number of CRC bits for the transmission based on a payload size of the transmission.

In certain representative embodiments, the processing of the transmission may include to determine channel coding from among a plurality of types of channel coding for the transmission based on a payload size of the transmission, and perform the determined channel coding.

In certain representative embodiments, a WTRU 102 may include circuitry, such as a transceiver and a processor, which is configured to perform any of the procedures described herein.

In certain representative embodiments, any of the procedures described herein may be implemented as a method by a WTRU 102.

As shown in FIGS. 9-17, reporting may be performed with respect to CSI-RS measurements. However, as described herein procedures may be modified and/or combined to use other RS (e.g., SSBs, TRSs) measurements.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). Atypical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A wireless transmit/receive unit (WTRU) comprising:
a processor and a transceiver which are configured to:
receive configuration information indicating a first set of transmission configuration index (TCI) states associated with a first scrambling identifier (ID) and a second set of TCI states associated with a second scrambling ID,
receive channel state information (CSI) reporting information indicating a first CSI reference signal (CSI-RS) resource set associated with the first set of TCI states and a second CSI-RS resource set associated with the second set of TCI states,
report first CSI including information indicating a quality of the first CSI-RS resource set based on one or more first measurements, wherein the one or more first measurements are based on the first CSI-RS resource set and the first scrambling ID, and
report, based on (1) the quality of the first CSI-RS resource set being less than a first threshold and (2) a difference between a quality of the second CSI-RS resource set based on one or more second measurements and the quality of the first CSI-RS resource set being greater than a second threshold, second CSI including information indicating the quality of the second CSI-RS resource set and a CSI-RS resource set indicator associated with the second CSI-RS resource set, wherein the one or more second measurements are based on the second CSI-RS resource set and the second scrambling ID.

2. The WTRU of claim 1, wherein the first scrambling ID is different than the second scrambling ID.

3.-4. (canceled)

5. The WTRU of claim 1, wherein respective TCI states of the first set of TCI states are each different than respective TCI states of the second set of TCI states.

6. The WTRU of claim 1, wherein at least one TCI state of the first set of TCI states is the same as at least one TCI states of the second set of TCI states.

7. The WTRU of claim 1, wherein the processor and the transceiver are configured to:
perform the one or more first measurements using the first CSI-RS resource set and the first scrambling ID,
activate the second CSI-RS resource set and deactivate the first CSI-RS resource set based on the quality of the first CSI-RS resource set being less than the first threshold, and
perform the one or more second measurements using the second CSI-RS resource set and the second scrambling ID.

8. The WTRU of claim 1, wherein the processor and the transceiver are configured to:
perform the one or more first measurements using the first CSI-RS resource set and the first scrambling ID,
receive a physical downlink control channel (PDCCH) transmission using a TCI state of the second set of TCI states,
activate the second CSI-RS resource set and deactivate the first CSI-RS resource set based on the PDCCH transmission, and
perform the one or more second measurements using the second CSI-RS resource set and the second scrambling ID.

9. The WTRU of claim 1, wherein the processor and the transceiver are configured to:
determine one or more TCI states of the first set of TCI states, and
determine one or more TCI states of the second set of TCI states,
wherein the one or more first measurements are performed using the first CSI-RS resource set, the first scrambling ID, and the determined one or more TCI states of the first set of the first set of TCI states, and
wherein the one or more second measurements are performed using the second CSI-RS resource set, the second scrambling ID, and the determined one or more TCI states of the second set of TCI states.

10. (canceled)

11. The WTRU of claim 1, wherein the processor and the transceiver are configured to:
receive information indicating a third set of TCI states associated with a third scrambling ID,
perform one or more third measurements using the second CSI-RS resource set and the third scrambling ID associated with the third set of TCI states, and
report CSI including information indicating the quality of the second CSI-RS resource set based on the one or more third measurements and a CSI-RS resource set indicator of the second CSI-RS resource set.

12. The WTRU of claim 1, wherein the quality of the first CSI-RS resource set is determined using any of a maximum measurement value, a minimum measurement value, and/or an average measurement value of the first measurements, and/or the quality of the second CSI-RS resource set is associated with any of a maximum measurement value, a minimum measurement value, and/or an average measurement value of the second measurements.

13. The WTRU of claim 1, wherein the quality of the first CSI-RS resource set and/or the quality of the of the second CSI-RS resource set includes any of a channel quality indicator (CQI), a signal to interference plus noise ratio (SINR), or a reference signal received power (RSRP) value.

14. A method implemented by a wireless transmit/receive unit (WTRU), the method comprising:
receiving configuration information indicating a first set of transmission configuration index (TCI) states associated with a first scrambling identifier (ID) and a second set of TCI states associated with a second scrambling ID;
receiving channel state information (CSI) reporting information indicating a first CSI reference signal (CSI-RS) resource set associated with the first set of TCI states and a second CSI-RS resource set associated with the second set of TCI states;
reporting first CSI including information indicating a quality of the first CSI-RS resource set based on one or more first measurements, wherein the one or more first measurements are based on the first CSI-RS resource set and the first scrambling ID; and
report, based on (1) the quality of the first CSI-RS resource set being less than a first threshold and (2) a difference between a quality of the second CSI-RS resource set based on one or more second measurements and the quality of the first CSI-RS resource set being greater than a second threshold, second CSI including information indicating the quality of the second CSI-RS resource set and a CSI-RS resource set indicator associated with the second CSI-RS resource set, wherein the one or more second measurements are based on the second CSI-RS resource set and the 2nd scrambling ID.

15. The method of claim 14, wherein the first scrambling ID is different than the second scrambling ID.

16.-17. (canceled)

18. The WTRU of claim 14, wherein respective TCI states of the first set of TCI states are each different than respective TCI states of the second set of TCI states.

19. The method of claim 14, wherein at least one TCI state of the first set of TCI states is the same as at least one TCI states of the second set of TCI states.

20. The method of claim 14, further comprising:
performing the one or more first measurements using the first CSI-RS resource set and the first scrambling ID;
activating the second CSI-RS resource set and deactivating the first CSI-RS resource set based on the quality of the first CSI-RS resource set being less than the first threshold; and
performing the one or more second measurements using the second CSI-RS resource set and the second scrambling ID.

21. The method of claim 14, further comprising:
performing the one or more first measurements using the first CSI-RS resource set and the first scrambling ID;
receiving a physical downlink control channel (PDCCH) transmission using a TCI state of the second set of TCI states;
activating the second CSI-RS resource set and deactivating the first CSI-RS resource set based on the PDCCH transmission; and
performing the one or more second measurements using the second CSI-RS resource set and the second scrambling ID.

22. The method of claim 14, further comprising:
determining one or more TCI states of the first set of TCI states; and
determining one or more TCI states of the second set of TCI states,
wherein the one or more first measurements are performed using the first CSI-RS resource set, the first scrambling ID, and the determined one or more TCI states of the first set of the first set of TCI states, and
wherein the one or more second measurements are performed using the second CSI-RS resource set, the second scrambling ID, and the determined one or more TCI states of the second set of TCI states.

23. (canceled)

24. The method of claim 14, further comprising:
receiving information indicating a third set of TCI states associated with a third scrambling ID;
performing one or more third measurements using the second CSI-RS resource set and the third scrambling ID associated with the third set of TCI states; and
reporting CSI including information indicating the quality of the second CSI-RS resource set based on the one or more third measurements and a CSI-RS resource set indicator of the second CSI-RS resource set.

25. The method of claim 14, wherein the quality of the first CSI-RS resource set is determined using any of a maximum measurement value, a minimum measurement value, and/or an average measurement value of the first measurements, and/or the quality of the second CSI-RS resource set is associated with any of a maximum measurement value, a minimum measurement value, and/or an average measurement value of the second measurements.

26. The method of claim 14, wherein the quality includes any of a channel quality indicator (CQI), a signal to interference plus noise ratio (SINR), or a reference signal received power (RSRP) value.
